(19) United States
(12) Patent Application Publication
(10) Pub. No.: US 2010/0325172 A1
(43) Pub. Date: Dec. 23, 2010

(54) Information Processing Apparatus and Method

(75) Inventors: Jun Maeda, Kawasaki (JP); Kazuo Sasaki, Kawasaki (JP); Takeshi Ohtani, Kawasaki (JP); Takeshi Sano, Kawasaki (JP); Masahiko Murakami, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/820,299

(22) Filed: Jun. 22, 2010

(30) Foreign Application Priority Data
Jun. 23, 2009 (JP) 2009-148402

(51) Int. Cl. G06F 17/30

(52) U.S. Cl. 707/803; 707/E17.044

(57) ABSTRACT

An information processing method, to verify condition data specifying conditions as to multiple attribute values of an object and attribute values obtained from said object, includes verifying processing to obtain a new attribute value after change for an attribute value having the smallest change frequency of attribute values not satisfying the conditions specified by said condition data, and verify whether or not the new attribute value after said change satisfy the conditions of said condition data; and further executing said verifying processing as to other attribute values not satisfying the conditions specified by said condition data in the case that said new attribute value after change for the attribute value having the smallest change frequency satisfies said conditions.

### CROSS REFERENCES TO RELATED APPLICATIONS

This application is based upon and claims the benefit of priority of the prior Japanese Patent Application No. 2009-148402, filed on Jun. 23, 2009, the entire contents of which are incorporated herein by reference.

### FIELD

The embodiments discussed herein are related to information processing.

### BACKGROUND

Heretofore, information systems have determined whether or not a condition is satisfied relating to an object or person subject to be processed, relating to various information processes.

For example, a system has been proposed which has combinations of client attribute values, references purchase history information and client attribute information for defined products, and calculates the client frequency of entries in an aggregate chart equivalent to combinations of attributes of clients with purchases, and extracts combinations of significant attribute values of the client frequencies.

Also, for example, a system has been proposed which receives input of a user profile, and selects content that is correlated to the user profile.

Further, for example, a system has been proposed which determines whether or not to communicate access to an object or a screen during display by a user. That is to say, determination is made as to whether or not a notification condition of whether or not to notify access detection, based on the information relating to access such as the user access content, the location of the display device that has been accessed, access detection history information, and access notification history information.

However, with the techniques heretofore, in the case of determining whether or not multiple attribute values relating to an object or person satisfy a condition, arrangements have not been made as to improving processing efficiency.

### SUMMARY

According to a certain aspect of the invention, an information processing method to verify condition data specifying conditions as to multiple attribute values of an object and attribute values obtained from said object, said information processing method includes verifying processing, by a processor, to obtain a new attribute value after change for an attribute value having the smallest change frequency of attribute values not satisfying the conditions specified by said condition data, and verify whether or not the new attribute value after said change satisfy the conditions of said condition data; and further executing said verifying processing as to other attribute values not satisfying the conditions specified by said condition data in the case that said new attribute value after change for the attribute value having the smallest change frequency satisfies said conditions.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a configuration example of an information system relating to a comparison example;

FIG. 2 illustrates a configuration example of an information system relating to a first embodiment;

FIG. 3 illustrates a processing example of an information system relating to a second embodiment;

FIG. 4 illustrates a system configuration example according to the second embodiment;

FIG. 5 illustrates a hardware configuration example of an application server;

FIG. 6 illustrates a processing flow example of a verification processing unit;

FIG. 7 illustrates a processing flow example of an information collecting unit;

FIG. 8 illustrates a (first) example of the operations of the verification processing;

FIG. 9 illustrates a (second) example of the operations of the verification processing;

FIG. 10 illustrates a (third) example of the operations of the verification processing;

FIG. 11 illustrates a processing flow example of generating an attribute value change frequency table relating to a first computation example;

FIG. 12 illustrates an example of an attribute value change frequency table relating to the first computation example;

FIG. 13 illustrates an example of an attribute value change frequency table relating to the first computation example;

FIG. 14 illustrates an example of an attribute value change frequency table relating to the first computation example;

FIG. 15 illustrates a processing flow example of generating an attribute value change frequency table relating to a second computation example;

FIG. 16 illustrates an example of an attribute value change frequency table relating to the second computation example;

FIG. 17 illustrates a processing flow example of generating an attribute value change frequency table relating to a third computation example;

FIG. 18 illustrates an example of an attribute value change frequency table relating to the third computation example;

FIG. 19 illustrates a processing example wherein the verification processing load decreases;

FIG. 20 illustrates a processing flow example of a verification processing unit in the case of using polling; and

FIG. 21 illustrates a processing flow example of an information collecting unit in the case of using polling.

### DETAILED DESCRIPTION OF THE PREFERRED EMBODIMENTS

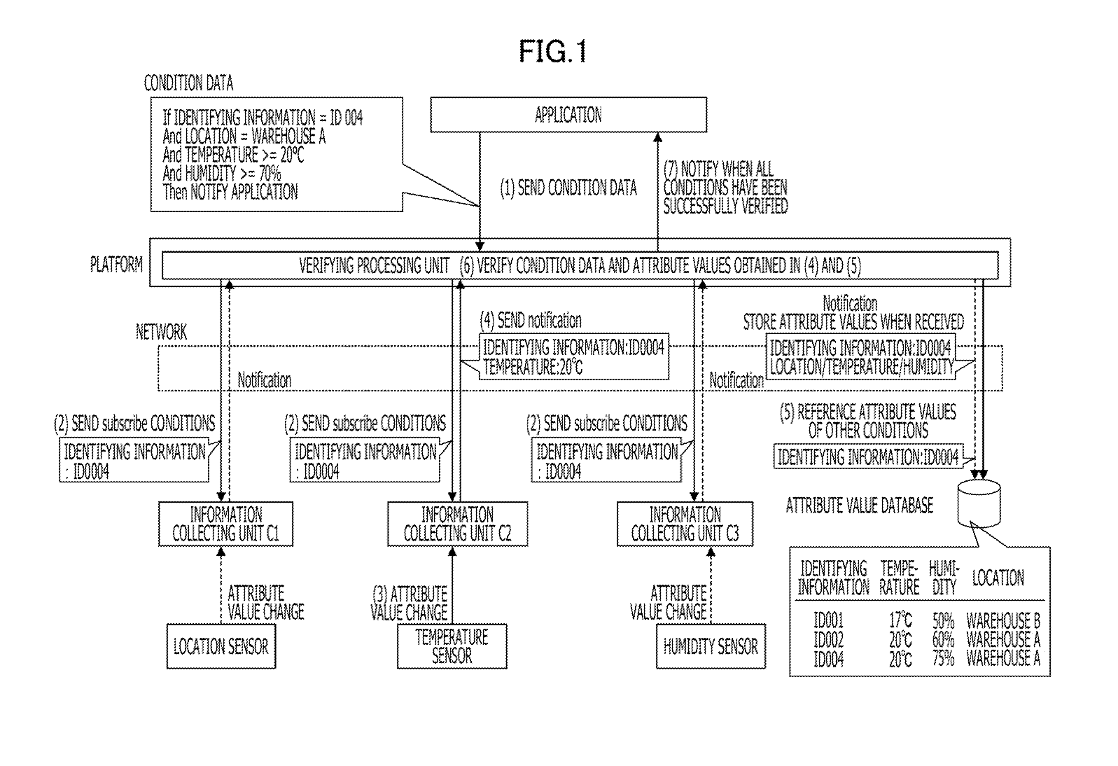

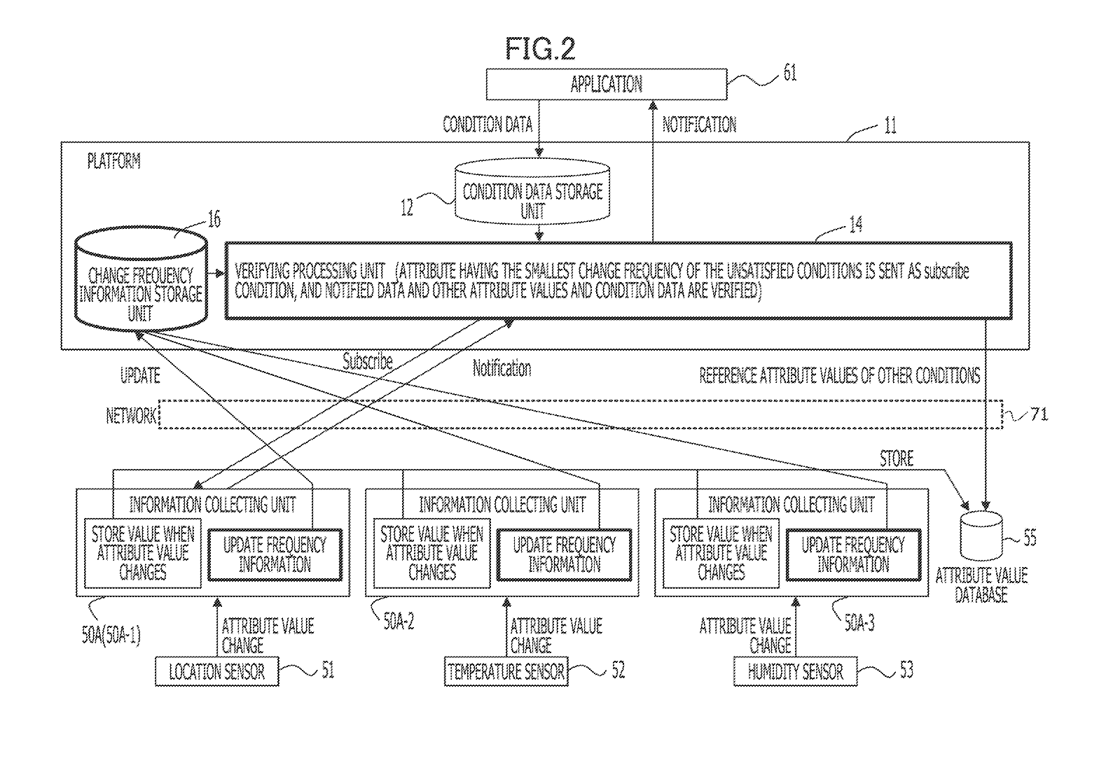

Hereafter, an information system according to an embodiment will be described with reference to the diagrams. (A) A first embodiment of an information system will be described with reference to FIGS. 1 and 2. The first embodiment relates to an information collecting unit that collects information relating to an object or person, and an information system that verifies whether or not the information collected by the information collecting unit satisfies conditions specified by an application, according to instructions from the application.

According to the first embodiment, the application hands over condition data to a platform, and requests verification of whether or not condition data has been satisfied. The condition data has multiple attribute values relating to an object or person, and conditions as to each attribute value specified therein. The platform obtains the attribute values included in the condition data from the information collecting unit, and determines whether or not the obtained new attribute values satisfy the condition data. Note that the information collecting unit monitors changes to the attribute values specified by the platform, and obtain new attribute values after the change. In the case that the condition data is satisfied, the platform notifies the application that the condition data is satisfied. Thus, the platform provides a function to manage the exchange of information between the application and information collecting unit.

FIG. 1 is a configuration diagram of an information system relating to a comparison example. The information system in FIG. 1 executes processing according to a Subscribe/Notify model in the first embodiment. According to the Subscribe/Notify model, the side that requests the information collection, e.g. the platform, specifies the request destination for information collection, i.e. the information to be collected in the information collecting unit. For example, the platform specifies an object that is to be monitored as to an information collecting unit C1 that can detect the location of an object, and requests collection of information relating to the location of the specified object.

Upon the information to be collected in the information collecting unit having been specified, the information collecting unit notifies new information after changing to the platform each time the collected information changes. For example, the information collecting unit C1 monitors a location sensor. Also, in FIG. 1, an information collecting unit C2 detects a temperature change of a temperature sensor, and an information collecting unit C3 detects a humidity change of a humidity sensor.

In FIG. 1, the platform has a verifying processing unit to execute verifying processing. The platform executes a computer program, for example, as a verifying processing unit. For example, let us assume a case that the verifying processing unit has requested the information collecting unit C1 to collect information relating to the location of a certain object. The information collecting unit C1 notifies the platform of the information relating to the new location of the object each time the location of the specified object detected by the location sensor changes.

Similarly, in the case that the platform requests the information collecting unit C2 to collect information relating to the temperature of a certain object, the information collecting unit C2 notifies the platform of the temperature detected each time the temperature detected by the temperature sensor set for each object changes. Also, in the case that the platform requests the information collecting unit C3 to collect information relating to the humidity in the periphery of a certain object, the information collecting unit C3 notifies the platform of the humidity detected each time the humidity detected by the humidity sensor set for each object changes.

Note that the temperature sensor and humidity sensor in the configuration in FIG. 1 are provided on the surface or within the object, for example, for each object. However, the temperature sensor and humidity sensor may be provided for each location that the location sensor has detected an object.

Upon the conditions of the condition data specified by the application having been satisfied, the verifying processing unit notifies the application that the specified condition data has been satisfied. For example, the information system in FIG. 1 processes the attribute values relating to an object wherein identifying information is identified by ID 004. With the information system in FIG. 1, for an object that has identifying information=ID004, the conditions specified by the application to the platform are that the location is warehouse A, the temperature is 20° C. or greater, and the humidity is 70% or greater. Upon the conditions for the identifying information=ID004 that the location is warehouse A, the temperature is 20° C. or greater, and the humidity is 70% or greater, the verifying processing unit notifies the application that the conditions have been satisfied.

The processing flow in FIG. 1 is as follows. The verifying processing unit receives condition data transmitted from the application (1). In many cases, conditions as to multiple attribute values relating to a target are specified in the condition data. The verifying processing unit then transmits registration conditions that identify information to be collected in each information collecting unit, corresponding to the specified multiple conditions (2). Note that in some cases the registration conditions specifying information to be collected in the information collecting units are called subscribe conditions. The information collecting units C1 through C3 and so forth transmit information (3) collected from a location sensor, temperature sensor, or humidity sensor respectively to the verifying processing unit (4). The information transmitted from the information collecting units C1-C3 and so forth to the verifying processing unit is also called a Notification. In the example in FIG. 1, a notification includes detection values of a location sensor, temperature sensor, or humidity sensor and so forth, i.e. new attribute values after changing.

Each time a notification indicating a change (3) for one of the values of the information collected with the information collecting unit is received (4), the verifying processing unit reads the attribute values specified with other conditions in the condition data from the attribute value database (5), and executes processing to research (6) whether or not the multiple conditions specified by the application have all been satisfied. Note that the newest values for each attribute are stored in the attribute value database by the information collecting units C1 through C3. For example, the attribute value database stores identifying information to specify an object, and the temperature, humidity, location, and so forth of the object specified with the identifying information.

In the case that the conditions of the condition data specified by the application are satisfied, the verifying processing unit notifies the application that verification of the conditions has succeeded.

A problematic point of the processing in FIG. 1 is that with processing wherein the verifying processing unit verifies whether or not multiple attribute values satisfy each of the conditions, each time a change to one attribute value is notified, processing to verify whether or not the conditions have been satisfied occur even for the other attribute values for which a change has not been notified.

According to the techniques in FIG. 1, the verifying processing unit requests the information collecting unit to notify the changed information when any of the information corresponding to the multiple conditions in the condition data has changed. Each time an information notification is made that is verified against one condition, for example, from the information collecting unit, the verifying processing unit researches whether or not multiple conditions are satisfied, including information other than the notified information. Therefore, there is a problem in that, in the case that there are identified conditions not satisfied for long periods of time, unnecessary verifying processing is performed each time notification corresponding to conditions other than the identified conditions arrive.

For example, in FIG. 1 we assume a case that the location of a target object is “warehouse B” and therefore will not change for a long time. Also, the temperature sensor and humidity sensor are assumed to be provided on the surface of, or within, an object, for example. The location condition indicated in the condition data is “warehouse A” so even in the case that the temperature of the object or the humidity and so forth in the periphery of the object changes, the location condition does not succeed. On the other hand, if the values of the temperature and humidity within the “warehouse B” change frequently, according to the technique in FIG. 1, notification is performed each time the value of the temperature or humidity changes. The verifying processing unit then operates, and regardless of the verifying not succeeding, the verifying processing unit performs verifying processing between each attribute value and the conditions in the condition data each time the value of the temperature or humidity changes.

We can presume that an environment will be realized in the future wherein numerous sensors and so forth exist with which the information system requests information collection, and a large amount of information is collected in a short interval. In an environment wherein a large amount of information is collected from numerous sensors in a short interval, information showing multiple attribute value changes is notified to the platform. Accordingly, the burden of verifying processing between the attribute values and condition data with the verifying processing unit is thought to increase.

FIG. 2 exemplifies a configuration of the information system according to the first embodiment. The information system in FIG. 2 includes a platform 11, information collecting units 50A-1, 50A-2, 50A-3 and so forth, and an attribute value database 55. Hereafter, in the case of summarizing the information collecting units 50A-1 and so forth, this is called an information collecting unit 50A. In FIG. 2, the platform 11 and the information collecting unit 50A are connected by a network 71. However, the information system in the first embodiment is not limited to the configuration in FIG. 2. For example, the platform 11 itself may include the information collecting unit 50A. Also, the application 61 and platform 11 may function on a single computer. For example, the application 61 and platform 11 and information collecting unit 50A may function on a single computer. Conversely, the application 61 and platform 11 and information collecting unit 50A may function by a shared processing on multiple computers.

At least the newest attribute values collected by the information collecting unit 50A are stored in the attribute value database 55. The attribute value database 55 can access the platform 11 via the network 71. Accordingly, the platform 11 can read attribute values of the attribute value database 55.

The information collecting unit 50A monitors the attribute values that the sensors monitoring each attribute have detected. For example, the information collecting unit 50A-1 obtains the attribute values relating to a location detected by the location sensor 51. The location sensor 51 is a tag reader indicating the location to position an item by reading an ID of the item from a tag attached to the item, for example. A tag reader may be a reading device for an RFID (Radio Frequency Identification) tag, or may be a barcode reader. The tag reading device reports the location information identifying the location that the device itself has set and the identifying information of the item read from the tag to the information collecting unit 50A-1. Also, the location sensor 51 may include a GPS chip to detect longitude and latitude. The GPS chip is attached to individual objects or people, and only has to report the detected location to the information collecting unit 50A-1. The information collecting unit 50A-1 has a database defining the locations corresponding to longitude and latitude, and only has to define the location of the object of which the position has been detected.

Also, the information collecting unit 50A-2 obtains the temperature of an item detected by the temperature sensor 52. Also, the information collecting unit 50A-3 obtains the humidity in the periphery of the item detected by the humidity sensor 53. The information collecting unit 50A stores the attribute values of the obtained temperature, humidity, and so forth in the attribute value database 55. The temperature sensor 52 or humidity sensor 53 may be attached to each item, for example. Also, the temperature sensor 52 or humidity sensor 53 may be attached in each location that can be detected by the location sensor 51, for example.

Similar to the case in FIG. 1, with the information system in FIG. 2, the platform 11 receives specifications of condition data from the application 61. The platform 11 holds the received condition data in a condition data storage unit 12 on the memory. The condition data includes the respective conditions as to the multiple attribute values collected by the information collecting unit 50A, for example. Also, the platform 11 has a verifying processing unit 14. A computer on which the platform 11 is installed executes a computer program as the verifying processing unit 14.

The verifying processing unit 14 verifies whether or not the attribute values collected by the information collecting unit 50A satisfy the conditions stored in the condition data storage unit 12. When the multiple conditions included in the condition data have been satisfied, the verifying processing unit 14 notifies the application 61 that the multiple conditions included in the condition data have been satisfied.

Compared to the information system in FIG. 1, the information system in FIG. 2 has the following differences. The platform 11 includes a change frequency information storage unit 16. The change frequency information storage unit 16 stores change frequency information indicating change frequency for each of multiple attribute values collected with the information collecting unit 50A. Further, the change frequency information storage unit 16 updates the change frequency information according to the change history of the attribute values collected by the information collecting unit 50A. Accordingly, the verifying processing unit 14 references the change frequency information storage unit 16, whereby change frequency can be obtained for each of the multiple attribute values collected by the information collecting unit 50A.

For example, the information collecting unit 50A records the newest changed attribute value in the attribute value database 55 when a change has occurred to an attribute value detected by a sensor, and holds the changed point-in-time as change information. The information collecting unit 50A aggregates the change information held in the past, computes the change frequency of the attribute value, and notifies the change frequency information storage unit 16.

For example, an aggregate number of pieces of attribute value change information may be converted to a number per time unit to be used, or the number of pieces of change information of the attribute values received within a fixed time from the current point-in-time may be used, as the change frequency of the attribute values thereof. However, the information collecting unit 50A may notify the change information of the attribute values on the platform 11 and the change frequency of the attribute values may be calculated at the platform 11. The platform 11 only has to store the calculated change frequency in the change frequency information storage unit 16.

In the verification of the attribute values and condition data in FIG. 2, the verifying processing unit 14 references the change frequency information storage unit 16 from within the conditions not satisfied, and selects the attribute value having the smallest change frequency of values. The verifying processing unit 14 requests attribute value collection as to the information collecting unit 50A which collects the attribute value having the smallest change frequency of the selected values.

The verifying processing unit 14 researches whether or not other multiple conditions included in the condition data have been satisfied when notification of the collected attribute values is received from the information collecting unit 50A requested to collected the attribute values. The processing to research whether or not the condition data is satisfied is called verifying processing. In the information system in FIG. 2, verifying processing is executed when the attribute value having the smallest change frequency in values has been notified. Accordingly, even if attribute values other than the attribute value having the smallest change frequency in values is changed, the verifying processing is not executed. That is to say, the information system in FIG. 2 reduces the burden of unnecessary verifying processing according to change of an attribute value having high change frequency. If the attribute having the smallest change frequency satisfied the condition, the verifying processing unit 14 requests information collection by the information collecting unit 50A as to the attribute value having the next smallest change frequency, thereby repeating similar processing.

By using the technique in FIG. 2 instead of the technique in FIG. 1, even if an attribute value having high change frequency, e.g. temperature/humidity and the like, changes, while the attribute value having low change frequency, e.g. value of the location, does not change, notification of the attribute value having high change frequency is not performed. Accordingly, verifying processing according to the change of the attribute value having high change frequency is not performed, and the burden of unnecessary verifying processing is reduced. That is to say, according to the information system in FIG. 2, verifying processing can be performed when the attribute value having the smallest change frequency of the unsatisfied conditions is focused upon and change is detected, and a change to the attribute value having the smallest change frequency is detected.

According to the information system in the first embodiment shown in FIG. 2, in the verifying of combination conditions for multiple attribute values, the verifying processing of attribute value and condition data can be suppressed to reduce the burden of verifying processing. Accordingly, for example, as compared to the information system in FIG. 1, a system can be realized economically with a smaller-scale machine configuration. Also, with the same scale configuration, the information system according to the first embodiment shown in FIG. 2 can obtain higher processing capability as compared to the information system in FIG. 1.

Advantages of the information system in FIG. 2 as compared to the information system in FIG. 1 become particularly significant in the case there is a large difference in change frequency of values between the multiple conditions. For example, in the case that conditions are the location that an item is positioned, the temperature of the environment where the item is positioned, and the humidity of the environment where the item is positioned, the following is assumed. That is to say, in the case that the location only changes once every few days and the temperature and humidity change every few minutes, with the information system in FIG. 1 the verifying processing is performed every few minutes. On the other hand, according to the information system in FIG. 2, during the time that the location is not satisfying the conditions, the verifying processing is only performed every few days.

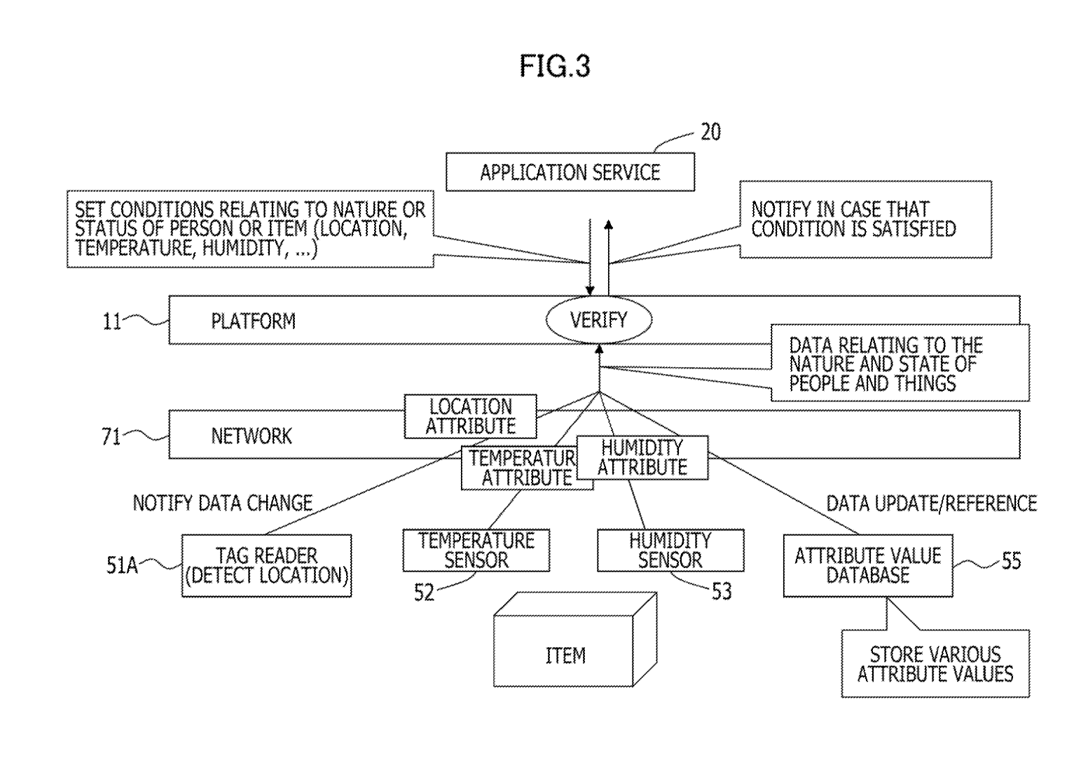

(B) An information system according to a second embodiment will be described below with reference to the diagrams in FIGS. 3 through 19.

FIG. 3 is a diagram exemplifying a processing overview of an information system according to the second embodiment. The information system of the second embodiment has an application server 20 that provides an application service, a platform 11, and various types of detecting devices that are connected to the platform 11 via a network 71. The various types of detecting devices include a tag reader 51A for detecting the location of items, a temperature sensor 52, humidity sensor 53 and the like, and an attribute value database 55 that stores the attribute value detected by the various types of sensors.

According to the second embodiment, as shown in FIG. 3, a shared platform 11 verifies the conditions specifying information that the application server 20 executing the various application services uses for operation, and information from the real world collected from various types of detecting devices via the network 71. The collected real-world information is data relating to the nature and state of a person or item, for example. More specifically, the collected real-world information can be exemplified by location attributes of an item, temperature attributes, humidity attributes, and so forth, for example. Location attributes are information indicating the location where an item is placed. The temperature attributes are the temperature of an item or the temperature data of the environment where an item is placed. The humidity attribute is the humidity of the environment where the item is placed.

For example, a tag reader 51A reads identifying information of the item from the RFID, thereby notifying the platform 11 of the location where the item having a read RFID has been placed. A detecting unit of the temperature sensor 52 is attached to the item, for example, and notifies the platform 11 of the measured temperature along with the identifying information of the item. Also, the detecting unit of the humidity sensor 53 is attached to the item, for example, and notifies the platform 11 of the measured humidity along with the identifying information of the item.

From the verifying processing at the shared platform 11, information from the real world is notified to the appropriate application service. An application server 20 processes the notified real world information, in the processing of each application service, and provides appropriate service to the user.

However, the verifying processing of the platform 11 and the relation between the platform 11 and application server 20 according to the present embodiment are examples, and the configuration of the information system is not limited to the present embodiment.

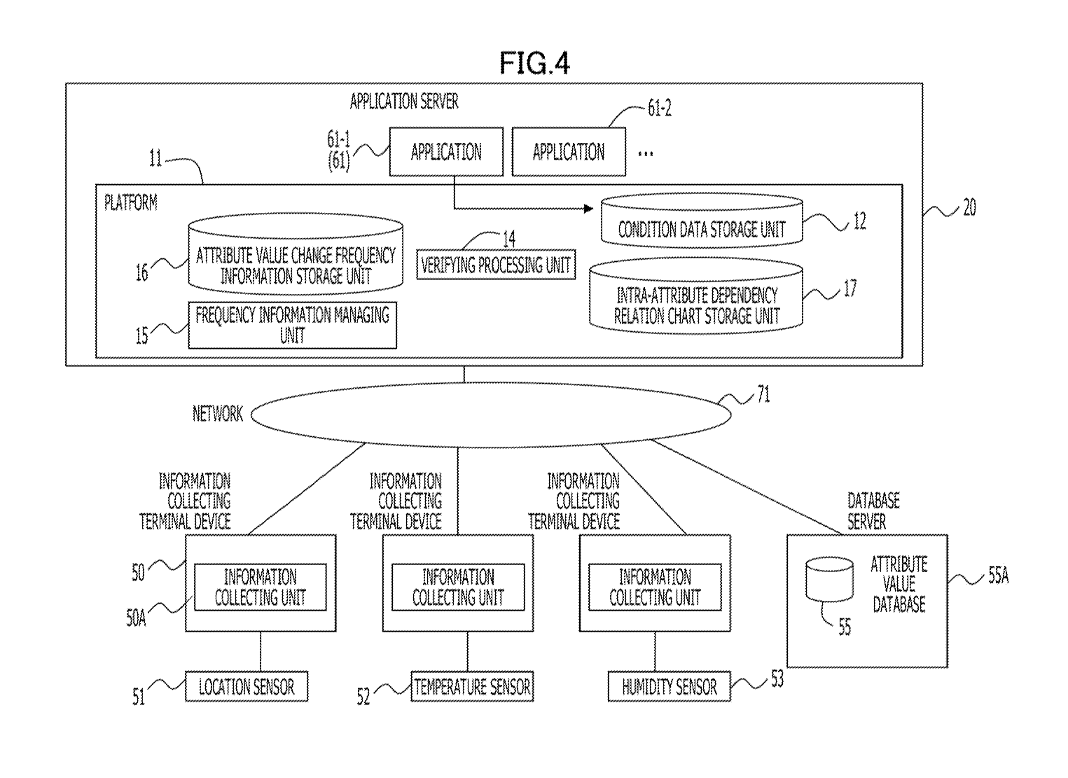

A system configuration according to the second embodiment is exemplified in FIG. 4. The information system according to the second embodiment has an application server 20, network 71, information collecting terminal device 50 that is connected to the network 71, database server 55A and so forth, location sensor 51 that is connected to the information collecting terminal device 50, temperature sensor 52 provided for each item, and humidity sensor 53 provided for each item.

With the configuration in FIG. 4, the application server 20 executes various types of applications 61-1, 61-2, and so forth. Hereafter, the various types of applications 61-1, 61-2, and so forth are summarized simply as application 61. Also, the application server 20 has a platform 11. In FIG. 4, the platform 11 has platform software including a verifying processing unit 14 and frequency information managing unit 15. Further, the application server 20 has storage units such as a condition data storage unit 12, attribute value change frequency information storage unit 16, and an intra-attribute dependency relation chart storage unit 17. The frequency information managing unit 15 is equivalent to the frequency calculating unit. Also, the attribute value change frequency information storage unit 16 is equivalent to the change frequency information storage unit. Also, the intra-attribute dependency relation chart storage unit 17 is equivalent to the dependency relation storage unit. The attribute value change frequency information storage unit 16 and the intra-attribute dependency relation chart storage unit 17 are under management of the platform software, whereby FIG. 4 shows this as a format included in the platform 11. Accordingly, with the configuration in FIG. 4, the platform 11 includes the platform software that the application server 20 executes and the storage units for various types of information managed by the platform software. For example, the application server 20 executes the frequency information managing unit 15, and manages and updates the attribute value frequency information of the attribute value change frequency information storage unit 16.

The attribute value frequency information is information indicating the frequency of change of various attributes provided from the information collecting terminal device 50, such as location attributes, temperature attributes, humidity attributes and so forth. The intra-attribute dependency relation chart storage unit 17 defines the dependency relation between attributes. The dependency relation between attributes is information defining that, in the case that the attribute value of one attribute is changed, the attribute values of other attributes are influenced. For example, upon the location of where an item is placed has been changed, the temperature, humidity, and so forth are to be measured anew in the changed location. That is to say, in accordance with the location change, there are cases wherein the attributes relating to the environment is reset. The location attributes and the dependency relation such as attributes relating to the environment are defined in the intra-attribute dependency relation chart storage unit 17.

The verifying processing unit 14 of the platform 11 receives instruction of the condition data from the application, holds this in the condition data storage unit 12, and executes the verifying processing.

The database server 55A has an attribute value database 55. The database server 55A stores the various attribute values notified from the information collecting terminal device 50 in the attribute value database 55. Also, the database server 55A provides the accumulated attribute values to the application server 20 according to request from the application server 20.

The information collecting terminal device 50 serves as the information collecting unit 50A to execute a computer program and monitor changes of the various attribute values. That is to say, upon the attributes that the device itself is responsible for, e.g. the attribute value of the location attribute, changing, the information collecting terminal device 50 accumulates the attribute values thereof in the attribute value database 55. Also, the information collecting terminal device 50 receives Subscribe conditions from the platform 11. The Subscribe conditions include specifications of attributes for the platform 11 to request an announcement of change to the information collecting terminal device 50. Upon attribute values corresponding to the Subscribe conditions changing, the information collecting terminal device 50 notifies the platform 11 that attribute values corresponding to the Subscribe conditions have changed. The Subscribe conditions can also, in different terminology, be called reservation conditions, in the sense of reserving a notification.

According to the configuration in FIG. 4, the application server 20 executes various types of applications 61 and the platform software. However, the configuration of the information system is not limited to the example in FIG. 4. For example, the various types of applications 61 and the platform software may be executed by different computers respectively. Also, applications 61 may be executed by different computers. Also, in FIG. 4, the attribute value database 55 is located on the database server 55A. However, for example, the various information collecting terminal device 50 may be arranged so as to accumulate databases by attributes for the various information collecting terminal devices 50 to monitor. That is to say, the databases may be distributed in the information collecting device 50 that is responsible for monitoring, by attributes to be monitored.

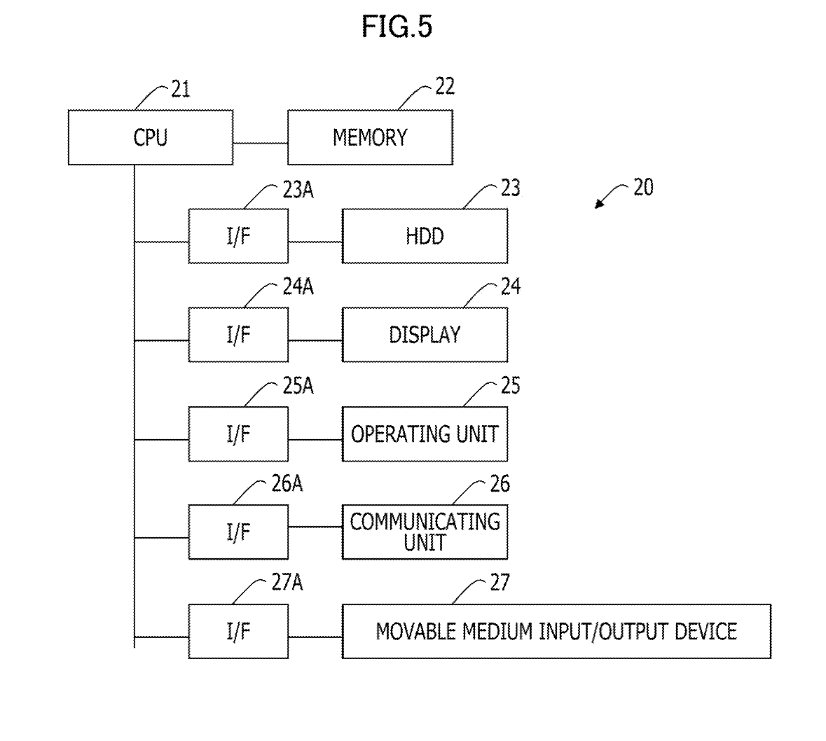

FIG. 5 exemplifies a hardware configuration of the application server 20. The application server 20 is a computer that can connect to the network 71. The application server 20 has devices such as a CPU 21, memory 22, hard disk drive 23 and the like, a display 24, operating unit 25, communicating unit 26, and detachable memory medium input/output device 27.

The CPU 21 executes a computer program expanded to be executable by the memory 22, and provides the function of the application server 20 or the function of the platform 11. The CPU 21 is not limited to one CPU, but may include multiple cores.

The memory 22 stores a computer program that the CPU 21 executes, data that the CPU 21 processes, and so forth. The memory 22 includes a non-volatile ROM (Read Only Memory) and a volatile DRAM (Dynamic Random Access Memory).

The computer program expanded to the memory 22 or the data and so forth processed by the CPU 21 are stored in a hard disk driven by the hard disk drive 23. Instead of the hard disk drive 23, a flash memory or the like such as SSD (Solid State Drive) may be used. The hard disk drive 23 or the external storage devices such as the SSD are connected to the CPU 21 via an interface 23A.

The interface 23A is, for example, an interface for a USB (Universal Serial Bus), IDE (Integrated Drive Electronics), SCSI (Small Computer System Interface), FC (Fibre Channel) or the like.

The display 24 is a liquid crystal display, electroluminescence panel, or the like, for example. The display 24 is, for example, connected to the CPU 21 via the interface 24A. The interface 24A is an interface for a graphics module such as VGA (Video Graphics Array) or the like, or DVI (Digital Visual Interface) or the like.

The operating unit 25 is an input device such as a keyboard, mouse, touch panel, electrostatic pad, and the like. An electrostatic pad is a device that detects user operations made by tracing a flat surface pad with a finger or the like, and is used to control the position and movement state of the cursor on the display 24 according to the user operations. For example, the movement of the user finger is detected by the change in electrostatic capacity of electrodes below the flat surface pad. The operating unit 25 is connected to the CPU 21 through the interface 25A. The interface 25A is a USB interface, for example.

The communication unit 26 is also called an NIC (Network Interface Card). The communication unit 26 is an interface for a LAN (Local Area Network), for example. The communication unit 26 is connected to the CPU 21 via the interface 26A. For example, the interface 26A is an expansion slot to connect the communication unit 26 to the internal bus of the CPU 21.

The detachable memory medium input/output device 27 is, for example, an input/output device such as a CD (Compact Disc), DVD (Digital Versatile Disk), Blu-ray disk, flash memory card or the like. The detachable memory medium input/output device 27 is connected to the CPU 21 via the interface 27A. The interface 27A is an interface for a USB, SCSI, or the like, for example.

Note that the configuration for the information collecting terminal device 50 is roughly similar to the application server 20 shown in FIG. 5. That is to say, the information collecting terminal device 50 has a CPU, memory, external storage device, display, operating unit, communicating unit, movable medium input/output device, and so forth. However, in the case that the information collecting terminal device 50 is operated remotely from the network 71, the display, operating unit, and movable medium input/output device and so forth are not needed.

Further, the information collecting terminal device 50 has an interface with the various types of detecting devices. For example, the interface that connects an RFID tag reader or bar code reader or the like which is the location sensor 51 with the CPU 21 may be a USB. Similarly, the interface between the temperature sensor 52 and humidity sensor 53 may be according to the standards of USB, CAN (Controller Area Network), or the like.

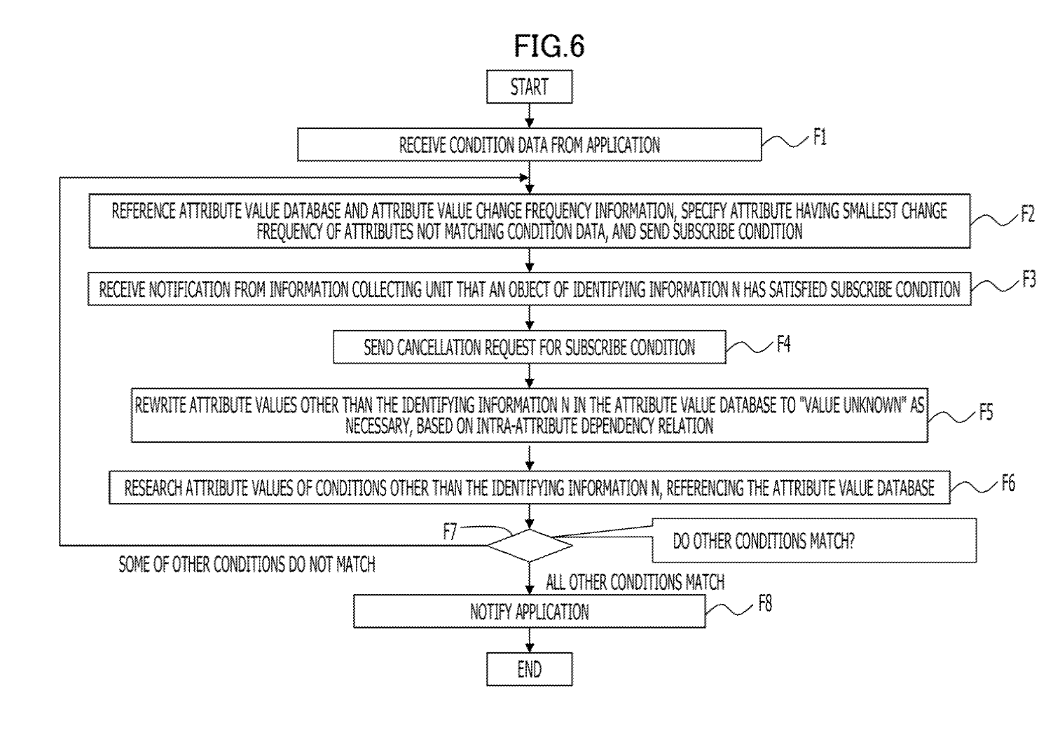

FIG. 6 exemplifies a processing flow of the verifying processing unit 14. The CPU 21 of the application server 20 executes the computer program expanded to the memory 22 as the verifying processing unit 14. According to the second embodiment, the processing of the CPU 21 is described as a function that the verifying processing unit 14 executes.

First, the verifying processing unit 14 receives the condition data from the application 61 (F1). Conditions for the attribute values relating to the application 61 are specified in the condition data. The attribute value conditions are, for example, (Condition 1) the object identified as identification information=N is placed in warehouse A, (Condition 2) the temperature of the object identified as identification information=N is maintained between T1 degrees and T2 degrees Celsius, and (Condition 3) the relative humidity at the periphery of the object identified as identification information=N is between H1 and H2.

Hereafter, let us assume that the object is specified as identification information=N. Also, the received condition data is maintained in the memory 22. The storage region on the memory 22 holding the received data is equivalent to the condition data storage unit 12 shown in FIG. 4.

The verifying processing unit 14 references the attribute value database 55 and identifies the attributes not matching the condition data. In the case there are multiple attributes not matching the condition data, the verifying processing unit 14 references the attribute value change frequency information storage unit 16, and determines the attribute having the smallest change frequency of the attributes not matching the condition data. The attribute having the smallest change frequency is determined from the attribute value change frequency information in the attribute value change frequency information storage unit 16. Note that in the case there is one attribute not matching the condition data, the attribute not matching the condition data is determined as is. The verifying processing unit 14 sets the identifying information to be obtained of the determined attribute value as the Subscribe condition. The verifying processing unit 14 then sends the Subscribe condition to the information collecting unit 50A of the information collecting terminal device 50 which collects the detected value from the detecting sensor of the determined attribute value (F2).

The verifying processing unit 14 awaits announcement from the information collecting unit 50A. In the state of awaiting announcement, the processing of the CPU 21 that executes the processing of the verifying processing unit 14 shown in FIG. 6 then awaits a schedule from the CPU 21. Consequently, the CPU 21 can execute processing other than the verifying processing 14.

Upon receiving the Subscribe condition, the information collecting unit 50A monitors the sensor of the attribute value specified with the received Subscribe condition. When the attribute value detected by the sensor changes, the information collecting unit 50A notifies the verifying processing unit 14 of the changed attribute value. The verifying processing unit 14 receives notification of the attribute value from the information collecting unit 50A through the OS (Operating System) of the application server 20, for example (F3). However, the communication between the information collecting unit 50A and the verifying processing unit 14 may be not via the OS. For example, the attribute value from the information collecting unit 50A may be notified to an input/output interface that the verifying processing unit 14 can read by way of the CPU 21. Upon the notification of the attribute value arriving, the input/output interface may cause the verifying processing unit 14 to interrupt by way of the hardware of the CPU 21. Upon receiving the notification from the information collecting unit 50A, the verifying processing unit 14 sends a cancellation request of the Subscribe condition to the information collecting unit 50A (F4).

Further, the verifying processing unit 14 references the intra-attribute dependency relation chart storage unit 17. Determination is then made as to whether or not the changed attribute value which is included in the received notification has a dependency relation that influences other attribute values. In the case that the changed attribute value which is included in the received notification has a dependency relation as to other attribute values, the other attribute values that are specified in the condition data as to an object having the identifying information N within the attribute value database and that have a dependency relation are rewritten as “value unknown” (F5). The CPU 21 of the application server which executes the verifying processing unit 14 executes the processing in F5 serving as an updating unit.

Next, the verifying processing unit 14 researches the attribute values of other conditions specified by the condition data as to the object of the identifying information N with the attribute value database 55 (F6). Determination is made as to whether or not the condition of the attribute value specified by the condition data satisfies the condition (F7). If there are multiple attributes not satisfying the condition specified by the condition data, the attribute having the smallest change frequency of attribute values is selected from the multiple attributes not satisfied. The verifying processing unit 14 sends the identifying information N as a Subscribe condition to the information collecting unit 50A which monitors the sensor that detects the attribute values of the attribute having the smallest change frequency. The is to say, the information collecting unit 50A returns the control to F2.

On the other hand, if all of the conditions are satisfied in the determination in F7, the verifying processing unit 14 notifies the application 61 of the identifying information N specified in the condition data and the various attribute values included in the condition data (F8). Note that the processing flow is omitted in FIG. 6, but in the case that all of the attributes match the condition data of the conditions received from the application 61, the processing from F2 through F6 is not executed, and according to the determination in F7, the control is advanced to F8 without change.

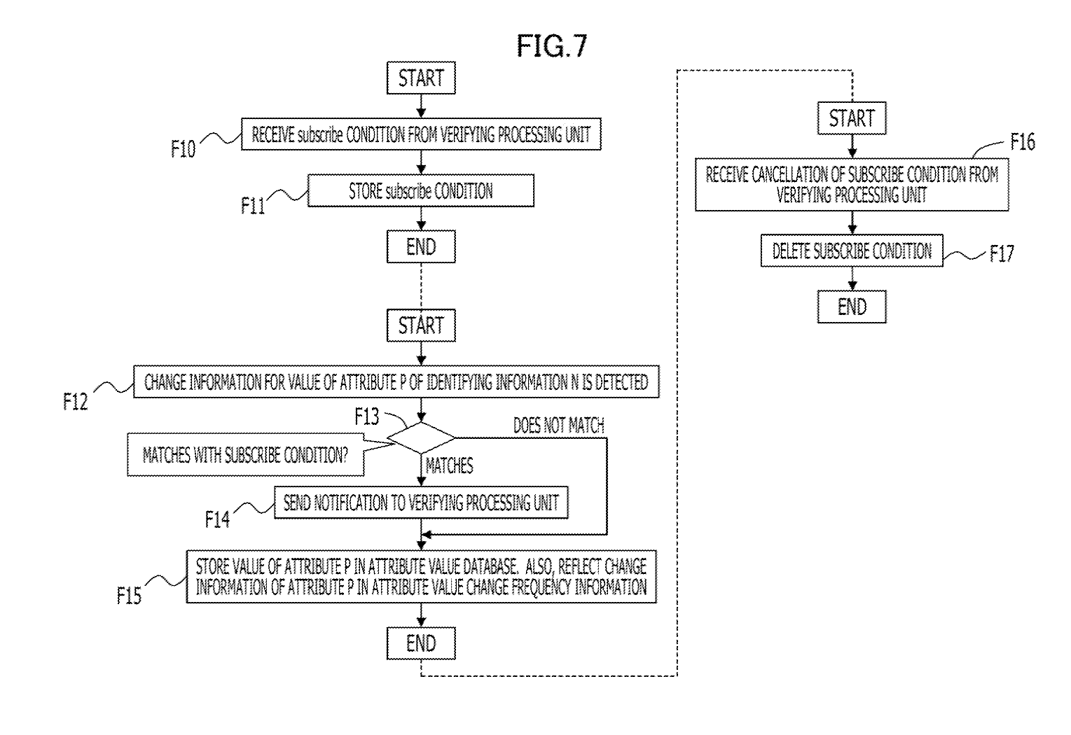

FIG. 7 exemplifies a processing flow of the information collecting unit 50A. The processing of the information collecting unit 50A in FIG. 7 includes a first process to receive the Subscribe conditions, a second processing to monitor the sensors, and a third process to delete the Subscribe conditions.

Upon receiving the Subscribe conditions from the first process (F10), the information collecting unit 50A stores the received Subscribe conditions in the memory 22 (F11). The Subscribe conditions are, for example, information relating to the identifying information N and the like.

The information collecting unit 50A monitors the information from the sensor that detects the attribute value P for an object of the identifying information N specified with the received Subscribe condition. That is to say, the information collecting terminal device 50A starts a second process to monitor the attribute value P.

With the second process, the information collecting unit 50A detects the change information of the value of the attribute value P (F12). Upon detecting a change to the attribute value from the sensor, the information collecting unit 50A determines whether or not the identifying information of the detected attribute value P matches the Subscribe condition. For example, the location sensor 51 detects identifying information that identifies an object as the identifying information. The information collecting unit 50A determines whether or not the identifying information N specified by the Subscribe condition has been detected with the location sensor 51 (F13). In the case that the identifying information N specified with the Subscribe condition is detected by the location sensor 51, the information collecting unit 50A notifies the verifying processing unit 14 of the sensor value detected. (F14)_{—}

Note that in either case whether or not the determination results of F13 match, the information collecting unit 50A stores the detected attribute values in the attribute value database 55. Also, the information collecting unit 50A updates the attribute value change frequency information storage unit 16. That is to say, the information collecting unit 50A notifies the frequency information managing unit 15 on the application server 20 that the detected value by the location sensor 51 has changed (F15). The second process, i.e. the processing from F12 through F15, is repeatedly executed until the Subscribe condition is deleted.

The information collecting unit 50A receives a cancellation of the Subscribe condition from the verifying processing unit 14 with the third process (F16). The information collecting unit 50A then deletes the Subscribe condition corresponding to the cancellation from the memory 22 (F17). With the cancellation of the Subscribe condition, the second process is stopped, and the information collecting unit 50A stops the processing of F12 through F15 which monitors the sensors. That is to say, even if an attribute value change occurs in the sensor information, notification to the verifying processing unit 14 is not performed due to the stopping in the second process.

<Operation Example of Verifying Processing>

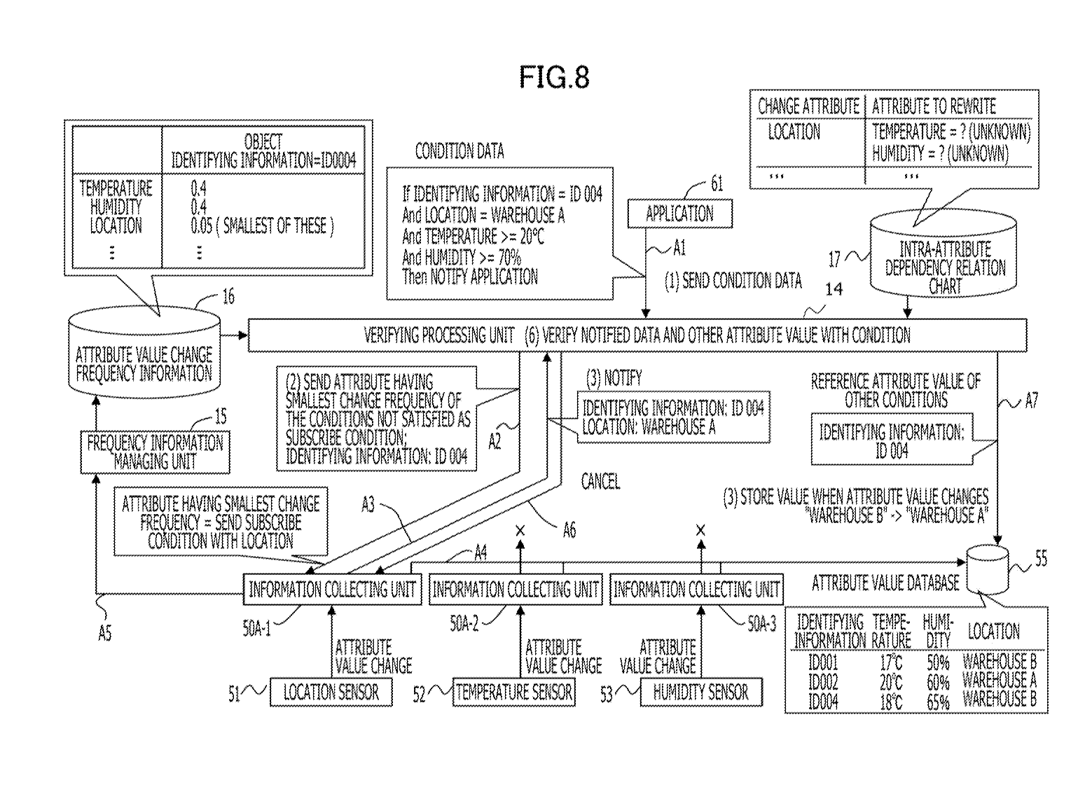

FIGS. 8 through 10 exemplify operations of the verifying processing of the information system according to the second embodiment. In the example in FIGS. 8 through 10, the condition data set from the application 61 is identifying information=ID 004; and location=Warehouse A; and temperature ≧20° C., and humidity ≧70%. That is to say, in FIGS. 8 through 10, processing relating to an object specified by identifying information=ID 004 is exemplified. The specified conditions indicate that the object specified by identifying information=ID 004 is in the warehouse A, that the temperature is 20° C. or greater, and that the relative humidity is 70% or greater.

Also, the attribute value change frequency information storage unit 16 stores a temperature change frequency 0.4, humidity change frequency 0.4, and location change frequency 0.05 for the identifying information=ID 004. Note that according to the second embodiment, the change frequency has no unit, and the numerical value indicates a comparative value of relative frequency between the mutual attributes.

Further, with the intra-attribute dependency relation storage unit 17, an attribute which value has changed and an attribute which receive influence from an attribute which value has changed are defined. For example, a standard is defined such as “in the case that the attribute which value has changed is location, the temperature and humidity are rewritten as unknown”. Description will be given below according to the data flow of the information system.

(1) The application 61 sends the condition data to the verifying processing unit 14 (arrow A1). The transmission of the condition data means a request from the application 61 to the verifying processing unit 14 to notify the application 61 when the condition specified by the condition data has been satisfied. As described above, the condition specified in FIG. 8, relating to the object specified by identifying information=ID 004, is that the object is in the warehouse A, the temperature is at 20° C. or greater, and the relative humidity is at 70% or greater.

(2) The verifying processing unit 14 sends the identifying information=ID 004 as a Subscribe condition to the information collecting unit 50A which collects the attribute value having the smallest change frequency of the received conditions (arrow A2). Details of the processing until the Subscribe condition is transmitted will be described below.

The verifying processing unit 14 references the attribute value database 55, and confirms that multiple conditions have not been satisfied relating to the identifying information=ID 004. The verifying processing unit 14 then references the attribute value change frequency information storage unit 16, and of the attributes subject to determination by the conditions specified as to the object of the identifying information=ID 004, the attribute having the smallest change frequency is identified as “location”.

In the example in FIG. 8, the information collecting unit 50A includes an information collecting unit 50A-1 that monitors the location sensor 51, an information collecting unit 50A-2 that monitors the temperature sensor 52, and an information collecting unit 50A-3 that monitors the humidity sensor 53. The verifying processing unit 14 sends the identifying information=ID 004 as a Subscribe condition to the information collecting unit 50A-1 that collects the attributes of “location” (arrow A2).

(3) Upon receiving the Subscribe conditions, the information collecting unit 50A-1 monitors the sensor information. If the attribute “location” of the object of the identifying information=ID 004 is detected as changed to “warehouse A”, the information collecting unit 50A-1 sends a notification to the verifying processing unit 14 (arrow A3). The notification of the arrow A3 includes information indicating that the attribute “location” of the object of the identifying information=ID 004 has changed to “warehouse A”. Also, the information collecting unit 50A-1 stores the “location” value “warehouse A” in the attribute value database 55 (arrow A4). Also, the information collecting unit 50A-1 requests the frequency information managing unit 15 to update the attribute value change frequency information storage unit 16 (arrow A5).

(4) Upon receiving notification, the verifying processing unit 14 sends a cancellation request of the Subscribe condition to the information collecting unit 50A-1 (arrow A6). The cancellation request is also called unsubscribe. Upon receiving the cancellation request for the Subscribe condition, the information collecting unit 50A-1 deletes the Subscribe condition from the memory 22. Note that the cancellation request only has to include information identifying the Subscribe condition to be cancelled, e.g. identifying information=ID 004 or the like.

(5) The verifying processing unit 14 references the intra-attribute dependency relation chart storage unit 17, and rewrites the attributes “temperature” and “humidity” of the identifying information=ID 004 within the attribute value database 55 as “value unknown”, e.g. “?”. The verifying processing unit 14 reads the attribute values other than the “location” of the identifying information=ID 004 from the attribute value database 55, i.e. “temperature” and “humidity” (arrow A7).

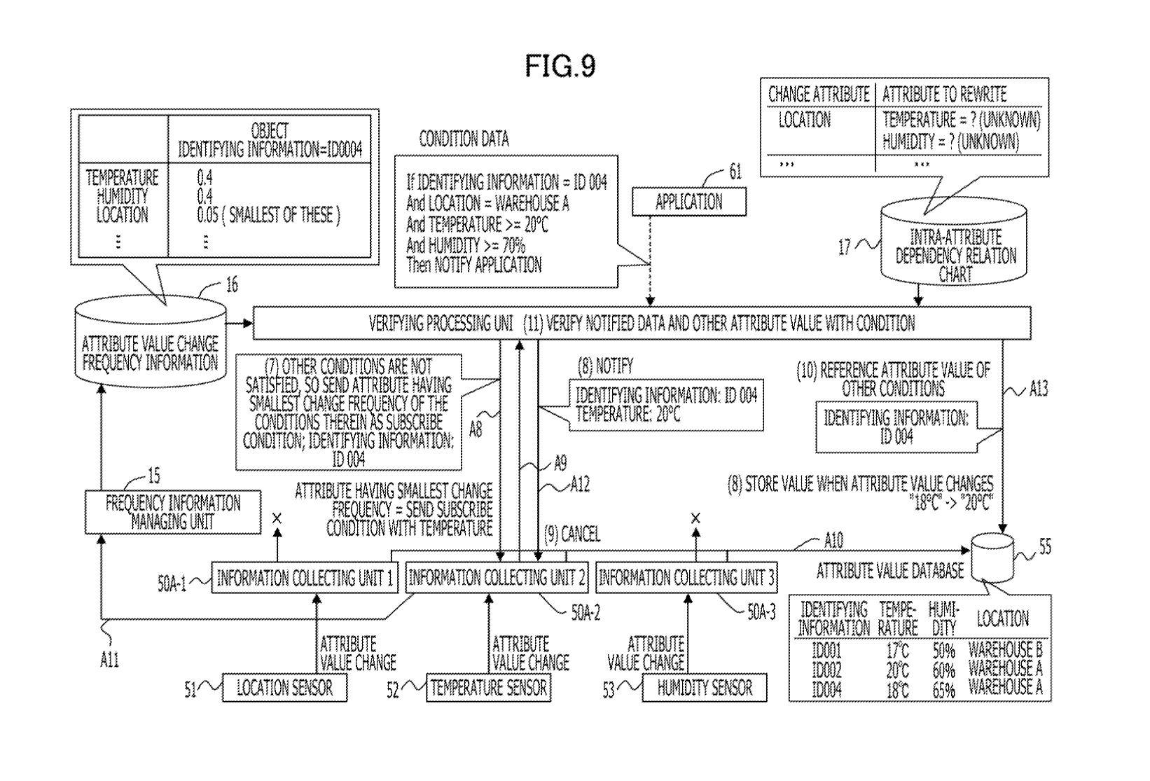

(6) The verifying processing unit 14 verifies the condition data and various attribute values. The description will be continued with reference to FIG. 9.

(7) If there are multiple attributes with conditions not satisfied, the verifying processing unit 14 sets the attribute having the smallest change frequency within the multiple attributes with conditions not satisfied as the Subscribe condition. In the case of the example in FIG. 9, the conditions of “temperature” and “humidity” are not satisfied. The verifying processing unit 14 references the attribute value change frequency information storage unit 16. In the example in FIG. 9, the change frequency of “temperature” and “humidity” both have the same value of 0.4. In the processing according to the second embodiment, the verifying processing unit 14 sends the identifying information=ID 004 as a Subscribe condition to the information collecting unit 50A-2 which collects the temperature information, according to the description order in the condition data (arrow A8).

(8) Upon receiving the Subscribe condition, the information collecting unit 50A-2 monitors the sensor information of the temperature sensor 51 that measures the temperature of the identifying information=ID 004. If the attribute “temperature” of the identifying information=ID 004 is detected as changing to “20° C.”, the information collecting unit 50A-2 sends a notification to the verifying processing unit 14 (A9). The notification includes the identifying information=ID 004 and detected temperature, e.g. 20° C. Note that in the example in FIGS. 8 through 10, a temperature sensor is provided for each object, and the temperature is measured for each object. Accordingly, the information collecting unit 50A-2 monitors the temperatures for multiple objects. The information collecting unit 50A-2 obtains the peripheral temperature of the object of the identifying information=ID 004 by obtaining the temperatures from the temperature sensors identified by identifying information=ID 004. Also, the information collecting unit 50A-2 stores the “temperature” value “20° C.” of the object of the identifying information=ID 004 in the attribute value database 55 (arrow A10), while requesting an update of the attribute value change frequency information storage unit 16 to the frequency information managing unit 15 (arrow A11).

(9) Upon receiving notification, the verifying processing unit 14 sends a cancellation request of the Subscribe condition to the information collecting unit 50A-2 (arrow A12). Upon receiving the cancellation request of the Subscribe condition, the information collecting unit 50A-2 deletes the Subscribe condition from the memory 22.

(10) In the case that the changed attribute value is humidity, the verifying processing unit 14 confirms from the intra-attribute dependency relation chart storage unit 17 that there is no rewriting of the attribute value database based on the intra-attribute dependency relation chart. The verifying processing unit 14 then reads out the attribute values for conditions other than the “temperature” (i.e. “location”, “humidity”) of the identifying information=ID 004 from the attribute value database 55 (arrow A13).

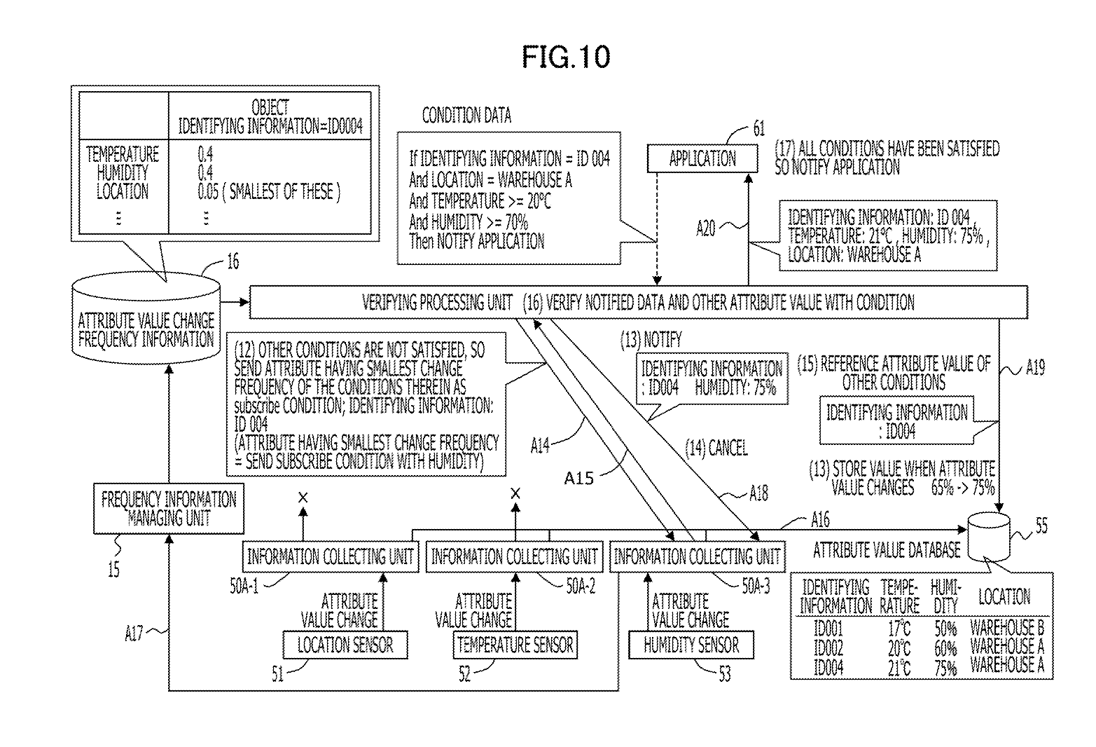

(11) The verifying processing unit 14 verifies the condition data and various attribute values. The description will be continued below with reference to FIG. 10.

(12) If there are any attributes for which the conditions in the condition data are not satisfied, the verifying processing unit 14 selects the attribute relating to the condition having the smallest change frequency therein as the Subscribe condition. In the case of the example in FIG. 10, only the condition of “humidity” has not yet been satisfied. Thus, the verifying processing unit 14 sends the identifying information=ID 004 which is the Subscribe condition to the information collecting unit 50A-3 which collects humidity information (arrow A14). (13) Upon receiving the Subscribe condition, the information collecting unit 50A-3 monitors the sensor information of the humidity sensor 53. If the attribute “humidity” of the identifying information=ID 004 is detected as having changed to “75%”, for example, the information collecting unit 50A-3 sends notification to the verifying processing unit 14 (arrow A15). The notification includes the identifying information=ID 004 and the humidity, e.g. 75%. Note that in the example in FIGS. 8 through 10, a humidity sensor 53 is provided for each object, and the humidity for each object is measured. Accordingly, the information collecting unit 50A-3 monitors the humidity for multiple objects. The information collecting unit 50A-3 obtains the humidity from the humidity sensor identified by the identifying information=ID 004, thereby obtaining the peripheral humidity of the object of the identifying information ID=004. Also, the information collecting unit 50A-3 stores the value “75% ” of the peripheral “humidity” of the identifying information=ID 004 in the attribute value database 55 (arrow A16), while requesting the frequency information managing unit 15 to update the attribute value change frequency information storage unit 16 (arrow A17). (14) Upon receiving notification the verifying processing unit 14 sends a cancellation request of the Subscribe condition to the information collecting unit 50A-3 (arrow A18). Upon receiving the cancellation request of the Subscribe condition, the information collecting unit 50A-3 deletes the Subscribe condition from the memory 22. (15) In the case that the changed attribute value is humidity, the verifying processing unit 14 confirms with the intra-attribute dependency relation chart storage unit 17 that the attribute value database 55 based on the intra-attribute dependency relation chart will not be rewritten. The verifying processing unit 14 reads the attribute values of the conditions other than “humidity” of the identifying information=ID 004 (i.e. “location”, “temperature”) from the attribute value database 55 (arrow A19). (16) The verifying processing unit 14 verifies the condition data and various attribute values. Note that the value of “temperature” is “21° C.” in FIG. 10 is because the temperature had changed from “20° C.” to “21° C.” during the time that the information collecting unit 50A-3 had been requested to monitor the humidity with the identifying information=ID 004 as the Subscribe condition, though not notified to the verifying processing unit 14. Regardless of the change from “20° C.” to “21° C.”, the temperature satisfies the condition, and consequently all of the conditions of the condition data specified by the application 61 are satisfied (A20). (17) The verifying processing unit 14 then notifies the identification information and attribute values to the application 61. The notification to the application 61 includes identifying information=ID 004; temperature=21 C, humidity=75%, and location=warehouse A.

<Computation Example of Attribute Value Change Frequency Information>

A procedure will be described, wherein, when the information collecting unit 50A detects an attribute value change, this is reflected in the attribute value change frequency information storage unit 16 by the detected attribute value change. According to the second embodiment, the attribute value change frequency information storage unit 16 stores an attribute value change frequency table. According to the second embodiment, computation examples are described for three ways of generating and updating the attribute value change frequency information. The information system may actually use a procedure for any of the computation examples. (Computation Example 1 of Attribute Value Change Frequency Information)

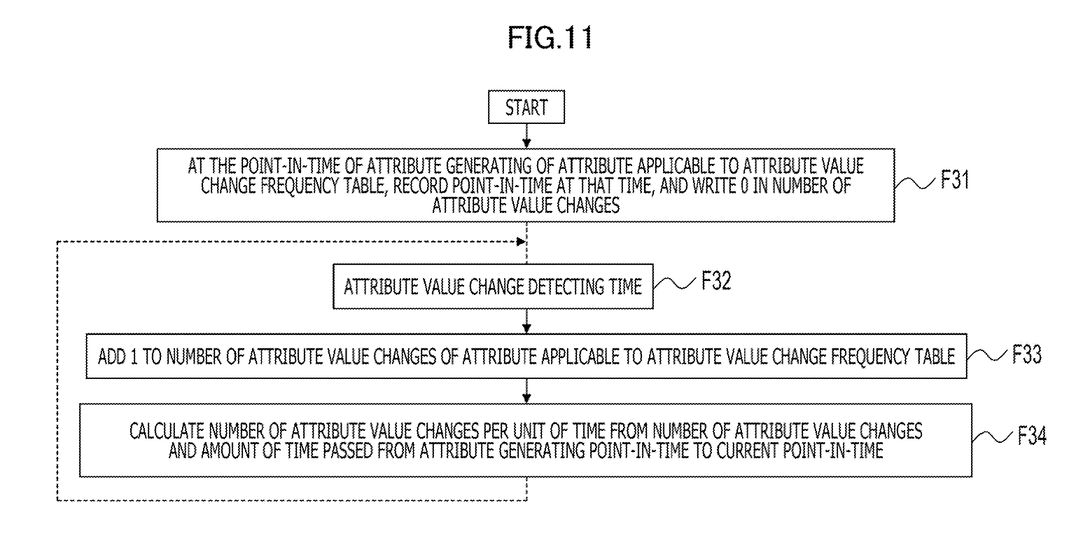

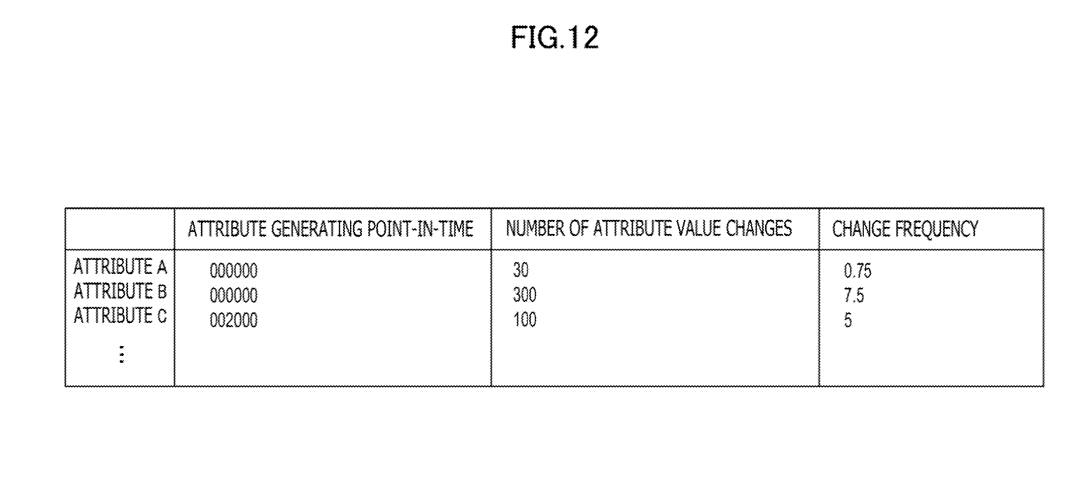

FIG. 11 exemplifies a processing flow for the attribute value change frequency table generating in the computation example 1. Also, FIG. 12 shows a data configuration of an attribute value change frequency table. The information system according to the second embodiment counts the number of attribute value changes each time the attribute value changes in actual practice. The information system calculates the number of changes per unit of time from the value of counted number of attribute value changes and the amount of time passed. By counting the actual number of attribute values changes, and calculating the number of changes per unit of time, the change frequency according to the attribute value changes is obtained. Note that there is no change frequency information in the initial state. However, after a certain amount of time has passed, and the number of attribute value changes has reached a sufficient number, a highly reliable change frequency can be obtained.

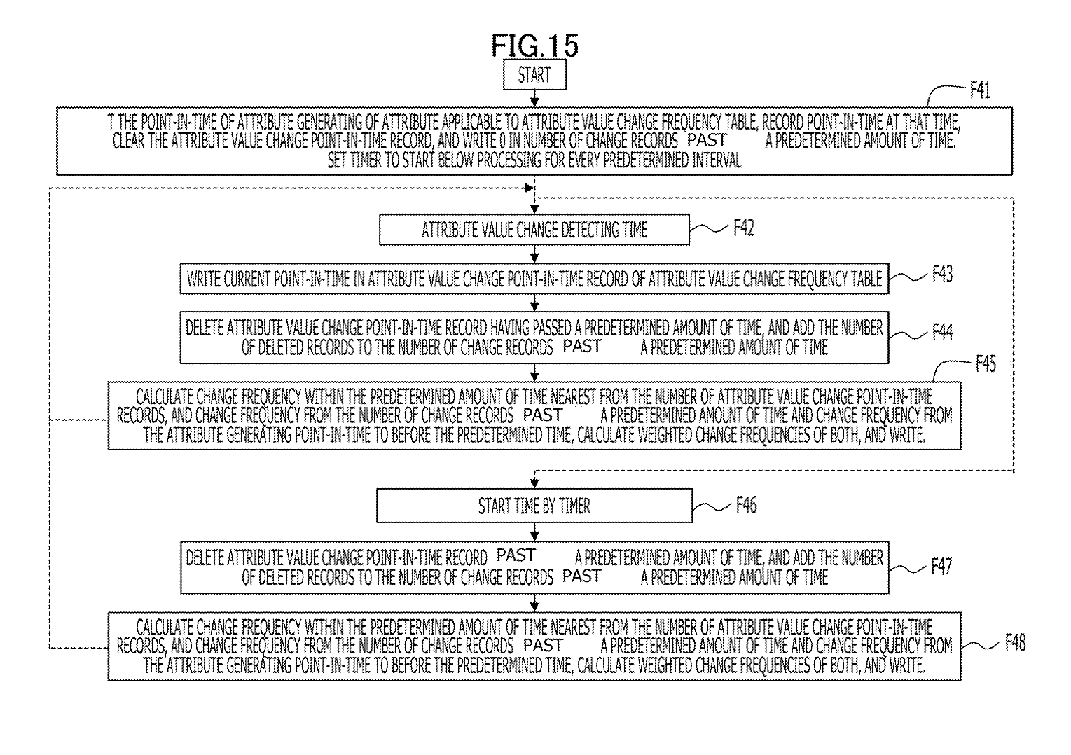

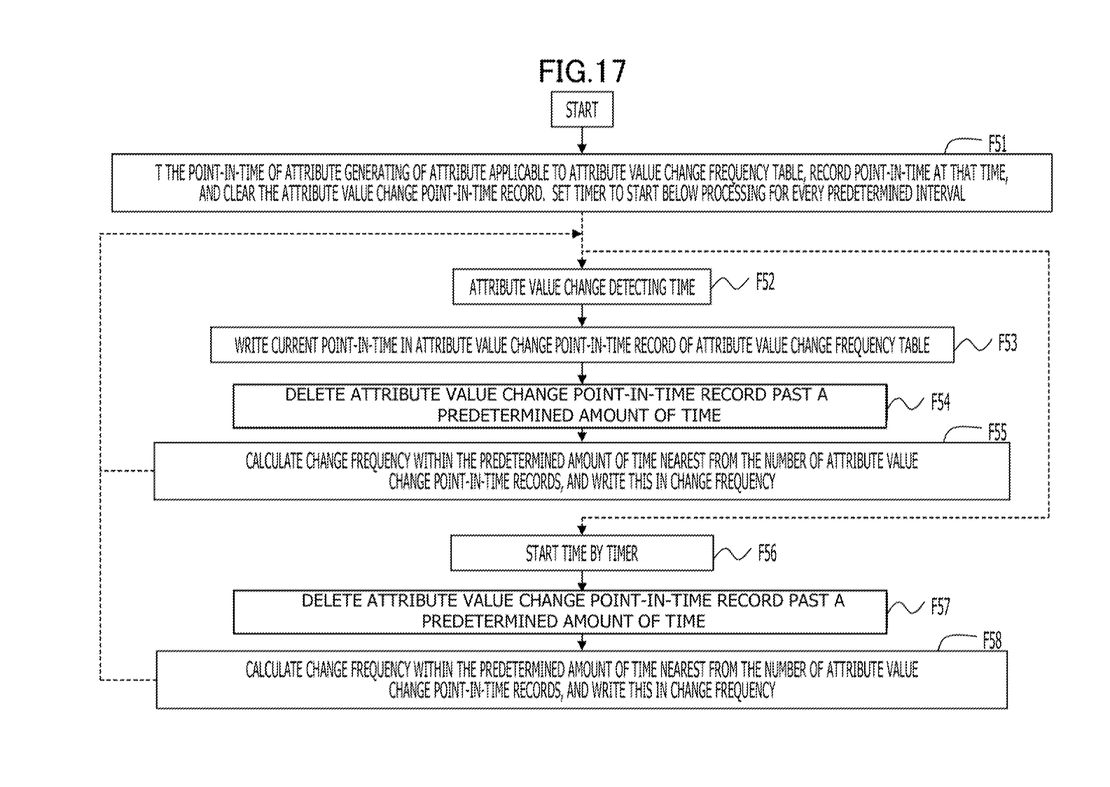

FIG. 11 is a flowchart showing the processing of the frequency information managing unit 15. However, instead of the frequency information managing unit 15, the information collecting unit 50A may execute the processing in FIG. 11. In the case that the information collecting unit 50A executes the processing in FIG. 11, the computation results of the change frequency by the information collecting unit 50A only has to be announced to the frequency information managing unit 15. Note that the processing in FIGS. 15 and 17 to be described later may be executed by either the frequency information managing unit 15 or the information collecting unit 50A.

The frequency information managing unit 15 records the current point-in-time in an attribute generating point-in-time of the attribute corresponding to the attribute value change frequency table as an initial value, and writes 0 in the number of attribute value changes (F31). The frequency information managing unit 15 then waits for detection of an attribute value change (F32). Upon receiving announcement of an attribute value change detection, the frequency information managing unit 15 adds 1 to the number of attribute value changes of the attribute corresponding to the attribute value change frequency table (F33). The frequency information managing unit 15 calculates the number of attribute value changes per unit of time from the number of attribute value changes and the amount of time passed from the attribute generating point-in-time to the current point-in-time. The frequency information managing unit 15 then writes the calculated number of attribute value changes in the corresponding attribute field in the attribute value change frequency table as the change frequency (F34). The frequency information managing unit 15 then returns control to F32, and awaits detection of the next attribute value change.

FIGS. 12 through 14 exemplify an attribute value change frequency table stored by the attribute value change frequency information storage unit 16. FIGS. 12 through 14 are examples each showing the difference in data ranges serving as the basis for calculating the change frequency. FIG. 12 is an example of an attribute value change frequency table computing the change frequency with multiple identifying information as the range thereof. The attribute value change frequency table in FIG. 12 shows the change frequencies of multiple attribute values identified by multiple identifying information=ID 001 through ID 004, for example. Alternatively, the attribute value change frequency table in FIG. 12 is applicable to a case of finding change frequency for an attribute targeting a member belonging to a certain group. For example, the attribute A may be the location of a member, and attribute B may be the body temperature of the member. As shown in FIG. 12, the attribute value change frequency table has various fields of attribute generating points-in-time, number of attribute value changes, and change frequency. Now, the attribute generating point-in-time is the point-in-time from which the information collecting unit 50A can detect change in attribute values. The number of attribute value changes is the cumulative number of attribute value changes from the attribute generating point-in-time to the present. The change frequency is a ratio obtained by dividing the number of attribute value changes by the time from the attribute generating point-in-time to the present.

The processing in FIG. 11 and the processing results in FIG. 12 can be said to be an example of having calculated the change frequency per unit of time from the aggregate number of attribute value changes in the past. Also, the frequency information managing unit 15 to execute the processing in FIG. 11 is equivalent to a frequency information calculating unit. According to the processing in FIG. 11, the actual number of attribute value changes are counted, and the change frequency according to the attribute value change can be found each time a change occurs, by calculating the number of changes per unit of time.

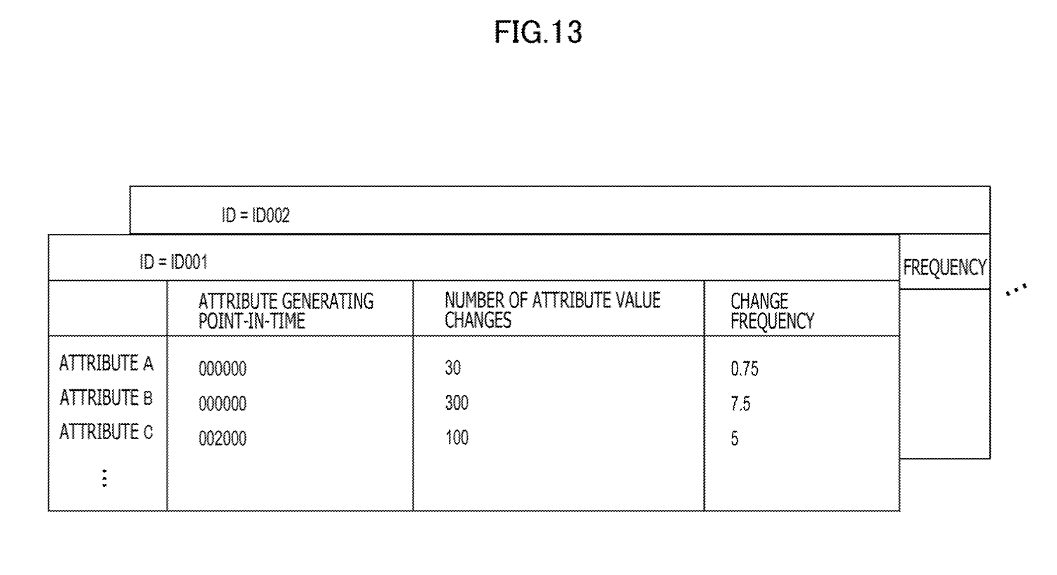

The attribute value change frequency table in FIG. 13 is an example of the attribute value change frequency table having computed the change frequency in the case that only one piece of identifying information is the range thereof. The attribute value change frequency table in FIG. 13 stores the attribute generating point-in-time, number of attribute value changes, and change frequency for each attribute relating to an object identified by the identifying information ID=001. Alternatively, the attribute value changing frequency table in FIG. 13 stores the information in the case of finding change frequency for the location of an identified person. By setting only one piece of identifying information as the range thereof, the attribute value change frequency matching an identified object can be obtained. In the case that the change frequency differs according to objects such as an item or person, the attribute value change frequency table in FIG. 13 is valid.

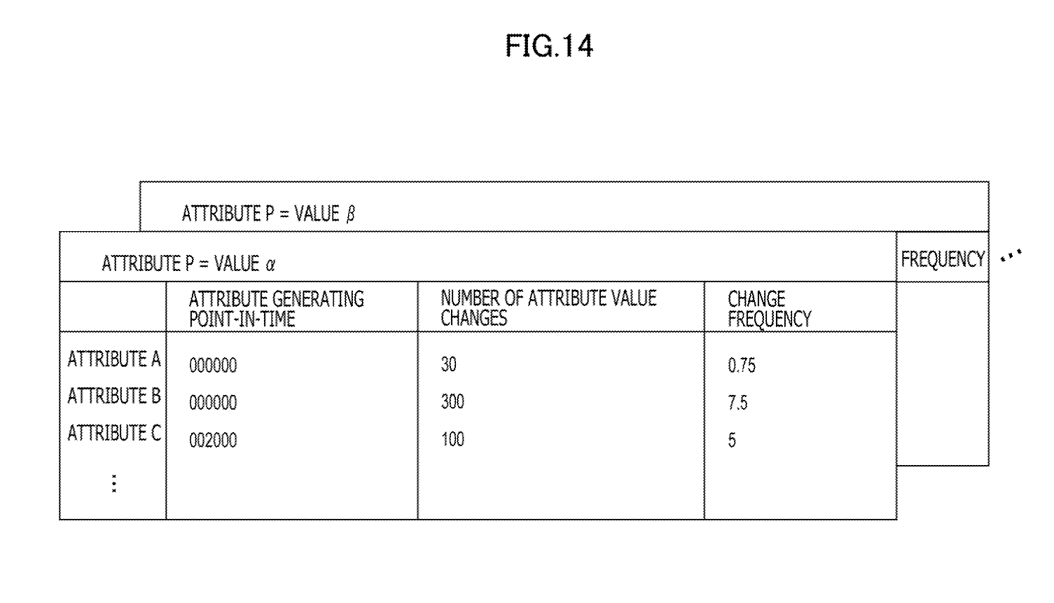

The attribute value change frequency table in FIG. 14 is an example in the case of satisfying a condition wherein an identified attribute has an identified value relating to multiple objects identified by multiple pieces of identifying information. That is to say, the attribute value change frequency table in FIG. 14 is selected by a certain attribute value, or includes change frequency information of an attribute value relating to a group of objects. For example, an attribute change frequency in the case of finding the change frequency of a location wherein a sub-group is the object, such as a group of people being divided by gender or age, is applicable to the table in FIG. 14. In FIG. 14, attribute value P=value α, or attribute value P=value β or the like becomes the condition for sub-group selection. The attribute value change frequency table includes data configuration in FIG. 14, whereby the change frequency can be obtained in the case that the verifying processing unit 14 detects that the attribute value of at least one attribute value satisfies the conditions of multiple shared objects.

Accordingly, the application 61 only has to notify the platform 11 of the condition data such that the attributes of objects specified by multiple pieces of identification information are monitored, with the conditions having identified values for identified attributes as shared conditions. The verifying processing unit 14 of the platform 11 verifies that the attribute values of multiple objects sharing at least one attribute value satisfies the condition of the condition data by similar procedures as the procedures shown in FIGS. 4, 6, 8 through 10 in the second embodiment, according to the specified condition data.

By selecting an object of a sub-group with the condition of satisfying a condition having an identified value for an identified attribute, a change frequency matching the object of shared attributes can be obtained. This is because, for example, in the case that the target is a person, in some cases the attribute change frequency will differ by gender, occupation, age, and so forth. Also this is because, for example, the attribute change frequency will differ for the attributes of an item, e.g. dimensions or materials. Also, in the case that the object is a plant or animal, in some cases the attribute change frequency will differ by biological attributes.

Note that the attribute value change frequency table in FIG. 13 can be considered an example using identifying information as the attribute values of multiple shared objects. The attribute value change frequency table shown in FIGS. 13 and 14, i.e. the attribute value change frequency table for objects having an identified value for an identified attribute is generated with generally the same procedures as the processing in FIG. 11. That is to say, in the processing in FIG. 11, the table shown in FIG. 13 or FIG. 14 may be used as the attribute value frequency table. However, in creating the attribute value change frequency table in FIG. 13, the change in attribute values of objects having identified identifying information should be monitored. Also, in creating the attribute value change frequency table in FIG. 14, the change in attribute values of objects having an identified value a for a certain attribute value should be monitored.

(Computation Example 2 of Attribute Value Change Frequency Information)

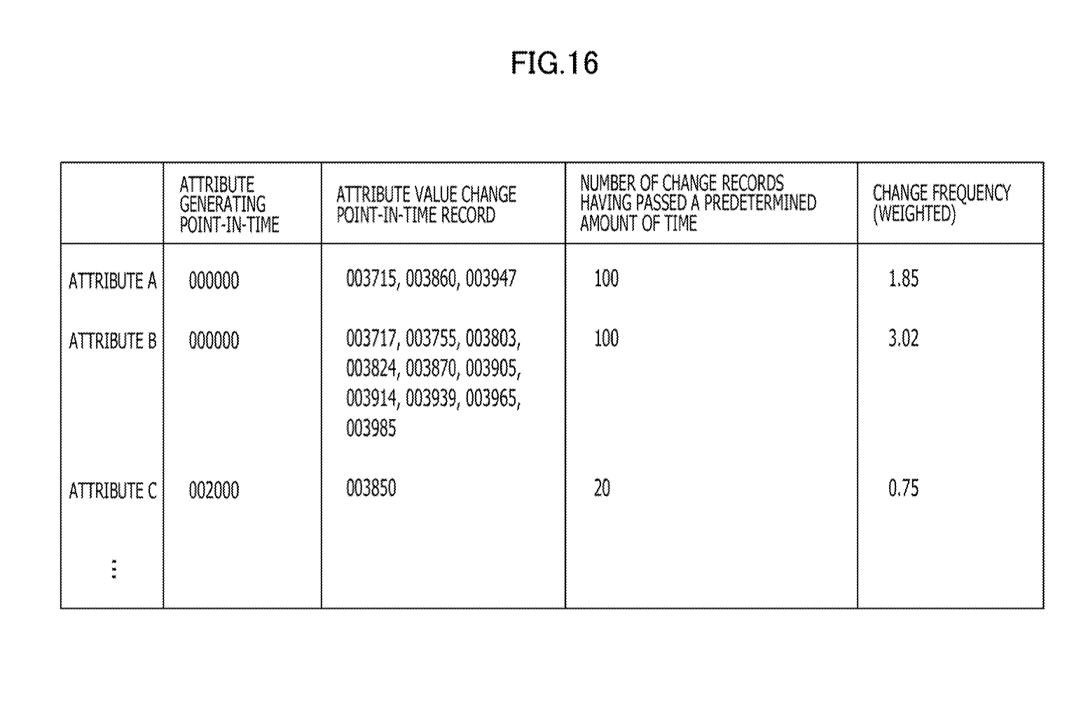

FIG. 15 shows a processing flow of a computation example 2 for generating and updating the attribute value change frequency table. FIG. 16 shows the data configuration of the attribute value change frequency table corresponding to a processing example in FIG. 15. In many cases the change frequency of the attribute values change along with time. The computational example 2 is a method considering the cases wherein the attribute value change frequency changes along with time. That is to say, in the processing in FIG. 15, the frequency information managing unit 15 divides change records for which a predetermined amount of time or more has passed, and change records occurring within a predetermined amount of time. The frequency information managing unit 15 records the changes within a predetermined amount of time by point-in-time. On the other hand, the frequency information managing unit 15 in FIG. 15 adds those which have passed a predetermined amount of time to the “number of change records past a predetermined amount of time”. The frequency information managing unit 15 may also change the weighting of the change frequency N1 obtained from the change records within the predetermined amount of time and the weighting of the change frequency N2 obtained from change records past a predetermined amount of time, to calculate a total change frequency. For example, the weighting of the change frequency N1 obtained from the change records within the predetermined amount of time should be made higher than the weighting of the change frequency N2 obtained from change records past a predetermined amount of time. Specific processing will be described below with reference to FIG. 15.

The frequency information managing unit 15 records the current point-in-time in the attribute generating point-in-time of the relevant attribute to the attribute value change frequency table, as an initial value. The frequency information managing unit 15 clears the attribute value change point-in-time record, and writes 0 in the number of change records past a predetermined amount of time. The frequency information managing unit 15 sets a timer to start the processing of F46 and thereafter at a predetermined interval (F41).

The frequency information managing unit 15 awaits detection of an attribute value change (F42). Upon receiving an announcement of attribute value change detection, the frequency information managing unit 15 writes the current point-in-time in the attribute value change point-in-time record of the attribute value change frequency table (F43). Next, the frequency information managing unit 15 deletes the attribute value change point-in-time record of passing a predetermined time T1, and adds the number of deleted records to the number of change records past the predetermined time T1 (F44). The predetermined time T1 may be set as a system parameter of the information system, for example.

Next, the frequency information managing unit 15 computes the change frequency N1 within the most recent predetermined time T1 from the number of attribute change point-in-time records. Also, the frequency information managing unit 15 computes the change frequency N2 as to the attribute value change past the predetermined time T1 according to the amount of time passed from the attribute generating point-in-time 0 to the predetermined point-in-time. The predetermined point-in-time is a point-in-time back in time from the present, by the amount of time T1.

The frequency information managing unit 15 calculates a weighted change frequency of the change frequencies N1 and N2, and writes this in the attribute value change frequency table (F45). The weighted change frequency can be an average weight of the change frequency N1 and the change frequency N2, for example. The frequency information managing unit 15 returns the control to F42, and awaits detection of the next attribute value change. F42 through F45 in FIG. 15 is called a first process.

On the other hand, when the timer marks the passing of a predetermined interval, the timer starts a second processing of F46 and thereafter by the frequency information managing unit 15. In the second process, the frequency information managing unit 15 deletes the attribute value change point-in-time record that has passed a predetermined time T1, and adds the number of deleted records to the number of change records past the predetermined time T1 (F47). The frequency information managing unit 15 computes the change frequency N1 within the predetermined time T1 near the number of attribute value change point-in-time records. Also, the frequency information managing unit 15 computes the change frequency N1 as to the attribute value changes past the predetermined time T1 by the amount of time passed, from the number of change records past the predetermined time T1 and the amount of time passed from the attribute generating point-in-time 0 until the predetermined point-in-time. Now, the predetermined point-in-time is a point-in-time back in time from the present, by the amount of time T1.

The frequency information managing unit 15 calculates the weighted change frequency of the change frequencies N1 and N2, and writes this in the attribute value change frequency table (F48). The frequency information managing unit 15 ends the second process, and awaits the starting of the next second process by the timer.

Accordingly, with the processing in FIG. 15, for example, even in the case that a change to the attribute value is not detected over a long period of time, the change frequency is calculated for each predetermined interval by the timer starting.

FIG. 16 exemplifies an attribute value change frequency table which is the processing result by the processing in FIG. 15. The example in FIG. 16 is generating point-in-time=000000, and records of attribute value changes from the current point-in-time=point-in-time 003999 are exemplified. From the generating point-in-time=000000 to the point-in-time 003699, the number of changes is recorded in a field of number of time stored for past the predetermined amount of time. On the other hand, the change records from the point-in-time 003700 to point-in-time 003999 have individual points-in-time recorded in the field of the attribute value change point-in-time records. In the example of FIG. 16, this is the predetermined time T1=003900-003700=299 used in the description in FIG. 15.

The frequency information managing unit 15 computes the change frequency N1 from the point-in-time 003700 to the current point-in-time. Also, the frequency information managing unit 15 calculates the change frequency N2 from the attribute generating point-in-time=000000 to the point-in-time 003699. The frequency information managing unit 15 calculates an average weighting of the change frequency N1 and change frequency N2. For example, instead of a weighted average, a simple average may be used with the same weighting.

Note that in FIG. 16, the attribute value change frequency table as to multiple pieces of identifying information in the format in FIG. 12 are indicated. However, with the processing shown in FIG. 15, this is applicable to the generating and updating of an attribute value change frequency table for each piece of identifying information as shown in FIG. 13, or an attribute value change frequency table for a selection of an identified attribute value or a group of attribute values as in FIG. 14.

(Computation Example 3 of Attribute Value Change Frequency Information)

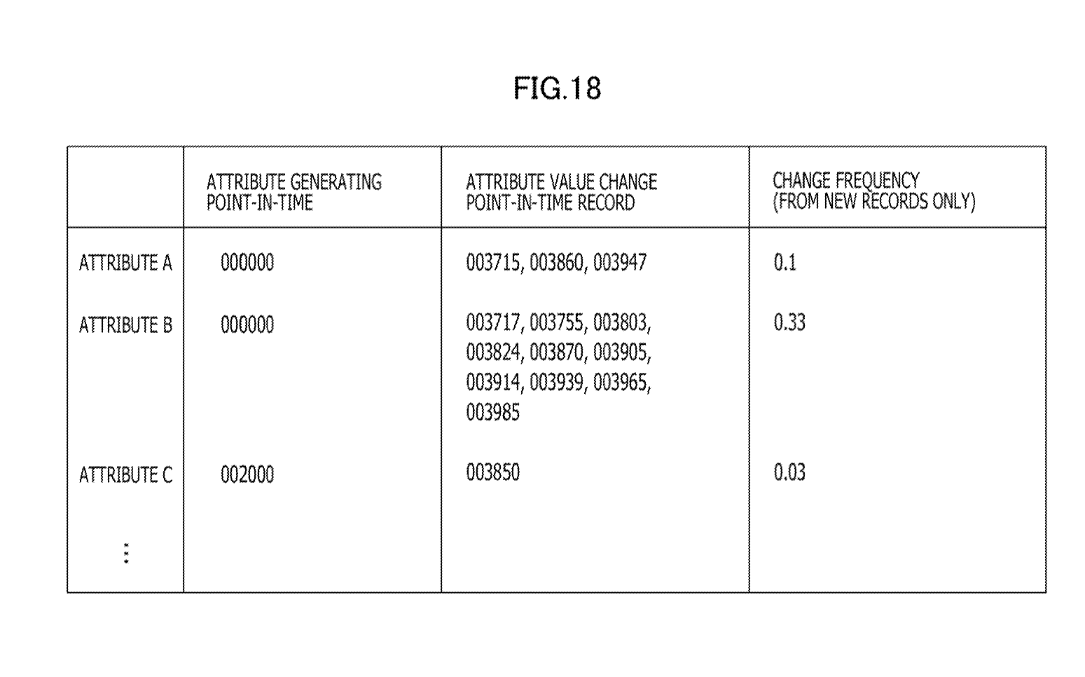

FIG. 17 shows a processing flow for a computation example 3 of the attribute value change frequency table generating. FIG. 18 shows an example of the attribute value change frequency table generated by the processing in FIG. 17. The computational example 3 is a computation of the change frequency by the attribute value changes before the attribute values prior to the predetermined time having passed, of the processing in FIG. 15, and acts as the results having deleted and calculated the attribute value changes past the predetermined time. Alternatively, the computation example 3 may be the result of setting the weighting to 0 as to the change frequency N2 based on the detection results of the attribute value change past the predetermined time T1 in the computation example 2.

That is to say, in the processing in FIG. 17, the processing from F51 through F53 is similar to the processing in F41 through F43 in FIG. 15. In the processing in FIG. 17, the frequency information managing unit 15 deletes the attribute value change point-in-time records past the predetermined time (F54). The frequency information managing unit 15 calculates the change frequency of the most recent predetermined time from the number of attribute value change point-in-time records, and writes this in the change frequency (F55). The processing from F52 through F55 is executed as the first process, similar to the case in FIG. 15.

Also, similar to the case in FIG. 15, when the timer marks the passing of a predetermined time, the timer starts a second process of F56 and thereafter by the frequency information managing unit 15. In the second process also, the frequency information managing unit 15 deletes the attribute value change point-in-time record that has passed a predetermined time (F57). The frequency information managing unit 15 computes the change frequency within the most recent predetermined time from the number of attribute value change point-in-time records, and writes this in the change frequency (F58).

FIG. 18 shows an example of the attribute value change frequency table created by the processing in FIG. 17. Note that FIG. 18 also, similar to the case in FIG. 16, shows an attribute value change frequency table as to the multiple pieces of identifying information in the format in FIG. 12. However, the processing shown in FIG. 17 is applicable to an attribute value change frequency table for each piece of identifying information as shown in FIG. 13, or can also be applicable to the generating and updating of the attribute value change frequency table that has been selected or grouped with an identified attribute value such as in FIG. 14.

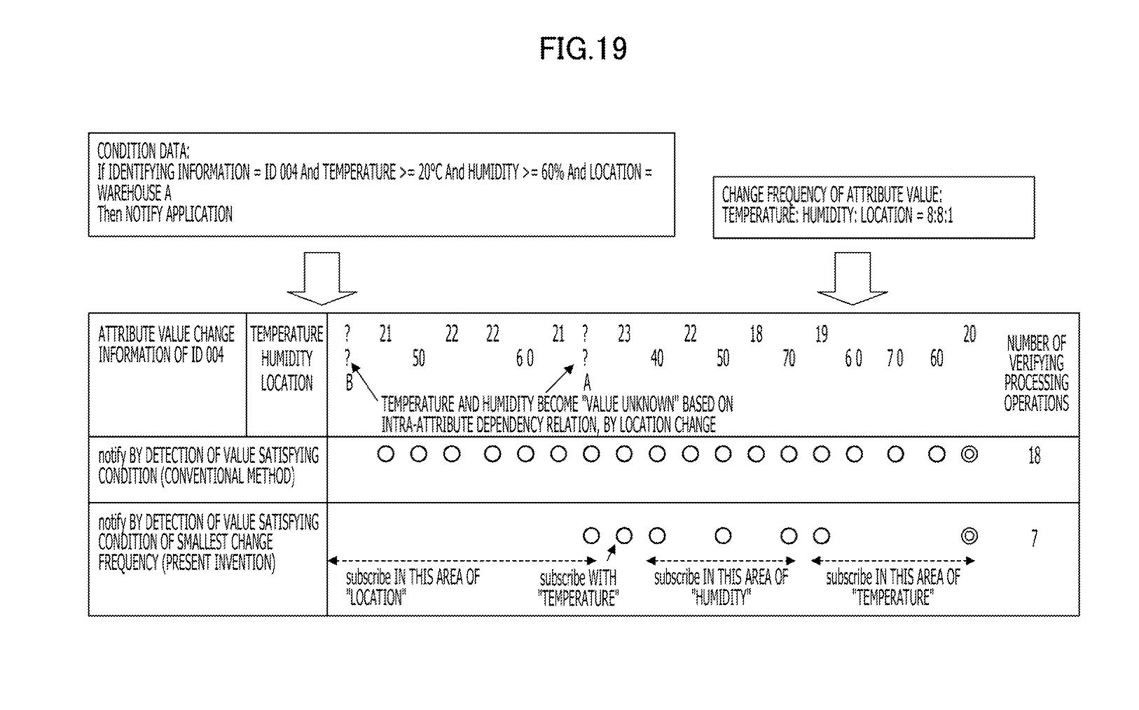

FIG. 19 exemplifies a processing to decrease the verifying processing burden. In FIG. 19, a case is assumed to set the condition data from the application 61 which is “for an object of an ID 004 item, if the temperature thereof is 20° C. or greater, the humidity is 60% or greater, and the location is in the warehouse A, then notify”.

Also, the change frequency for each attribute value is assumed to have the same change frequency for temperature and humidity, and that the change frequency for the temperature and humidity is eight times the change frequency of the location. The processing in the verifying processing unit 14 researches the attribute value database 55 for the location having the attribute with the smallest change frequency, and finds that the ID 004 item is in warehouse B. The location being in warehouse B does not satisfy the condition. Thus, the verifying processing unit 14 sends a Subscribe condition to the information collecting unit 50A-1 regarding the ID 004 item so that the change in location as an attribute will be detected. Upon sending the Subscribe condition, until the location of the ID 004 item is changed to warehouse A, the temperature and humidity of the ID 004 item changes periodically such as temperature is 21° C., humidity is 50%, temperature is 22° C., and so forth. However, the verifying processing unit 14 does not operate regarding change in the temperature or humidity which is other than the Subscribe condition. That is to say, the verifying processing unit 14 avoids the unnecessary verifying processing executed with the method in FIG. 1 each time.

Upon the location of the ID 004 item becoming warehouse A, notification is performed from the information collecting unit 50A-1 to the verifying processing unit 14. At this time, at the verifying processing unit 14, first, the temperature and humidity are rewritten as “value unknown” since there has been a change to location, with the intra-attribute dependency relation chart 17 exemplified in FIG. 8. The attribute having the greatest change frequency is selected for the subscribe condition. The temperature and humidity have the same frequency, so based on the description sequence of the condition data, the temperature is notified to the information collecting unit 50A-2 as the Subscribe condition. The temperature change is notified from the information collecting unit 50A-2 to the verifying processing unit 14 in a short time compared to the location. Since the temperature condition has been satisfied, the verifying processing unit 14 selects humidity as the Subscribe condition next, and notifies this to the information collecting unit 50A-3. Similar to the case of the temperature, in a relatively short time, humidity=70% is notified from the information collecting unit 50A-3 to the verifying processing unit 14, and the humidity condition is satisfied. When the verifying processing unit 14 searches attributes other than the humidity in the attribute value database 55, the temperature shows 18° C., and is not satisfying the condition. Therefore, the verifying processing unit 14 notifies the information collecting unit 50A-2 of the temperature as the subscribe condition again. Humidity changes thereafter are not notified from the information collecting unit 50A-3 to the verifying processing unit 14, and unnecessary verifying processing is omitted. Finally when the temperature of 20° C. is notified from the information collecting unit 50A-2 to the verifying processing unit 14, the other attribute values all satisfy the conditions thereof. Thus, the verifying processing unit 14 notifies the application 61 of the attribute values corresponding to the condition data. Compared to the attribute value changes with the method described above, with the method in FIG. 1, the verifying processing operates 18 times. On the other hand, according to the method in the second embodiment, the verifying processing is reduced to seven times, and the processing is more efficient.

As described above, with the verifying processing in the second embodiment, an attribute having low change frequency is focused upon, and first, for attribute values not satisfying conditions defined by the condition data, subscribe conditions are notified to the information collecting unit 50A, and notification of attribute value changes are requested in the order of low change frequency. Consequently, unnecessary verifying processing, which occurs with attribute value changes having high change frequency, can be suppressed.

Also, with the information system according to the second embodiment, for example, upon the attribute value change of the location of an object which is an item or person having been detected, the attribute values of temperature, humidity, and so forth have been changed to value unknown according to the dependency relation of the intra-attribute dependency relation chart storage unit 17. Accordingly, with the information system according to the second embodiment, even in the case wherein one attribute value change has been detected at one point and the detected attribute value satisfies the condition data, the other attribute values are reset according to the other attribute value changes, whereby each attribute value can more accurately be determined as to whether or not the condition data is satisfied.

<Modification> According to the second embodiment, a temperature sensor 52, humidity sensor 53, and so forth are provided for each object identified by the identifying information. Instead of the configuration described with the second embodiment, a temperature sensor to detect environmental temperature or a humidity sensor to measure the relative humidity in the environment may be provided for each location that the location sensor 51 can identify. Accordingly, for example, in the case that the verifying processing unit 14 detects location change relating to an object specified by the identifying information, the information collecting unit 50A which monitors the temperature or humidity can then be notified of the Subscribe condition, with the changed location identifying information as the Subscribe condition thereof.

(C) According to the second embodiment, the verifying processing unit 14 focuses on an attribute having low change frequency, sends the subscribe condition to the information collecting unit 50A, and requests notification of the attribute value change. Upon the information collecting unit 50A detecting the change of the attribute value corresponding to the Subscribe condition, a notification is sent to the verifying processing unit 14. Instead of the processing of a detection request for changes by the subscription of the Subscribe condition and an announcement of attribute value changes that match the requested Subscribe conditions as with the second embodiment, a method of polling may be used. In the case of polling, the system configuration is similar to FIG. 4. Also, with the information system according to the third embodiment, the attribute value database 55 is not necessary. This is because it is difficult to have consistency between the information system for verifying processing unit 14 polling the information collecting unit 50A and the configuration to write in the detected attribute value that the information collecting unit 50A writes in the attribute value database 55. Further, according to the third embodiment, an information system not providing an intra-attribute dependency relation chart storage unit 17 is described, but an intra-attribute dependency relation chart storage unit 17 may be provided and an intra-attribute dependency relation may be used for processing, similar to the second embodiment.

Also, the configuration of the condition data storage unit 12 that stored the condition data received from the application 61 and the attribute value change frequency information storage unit 16 are similar to the case of the second embodiment. In the case of using polling, the processing of the verifying processing unit 14 and the information collecting unit 50A differ from the case of the second embodiment.

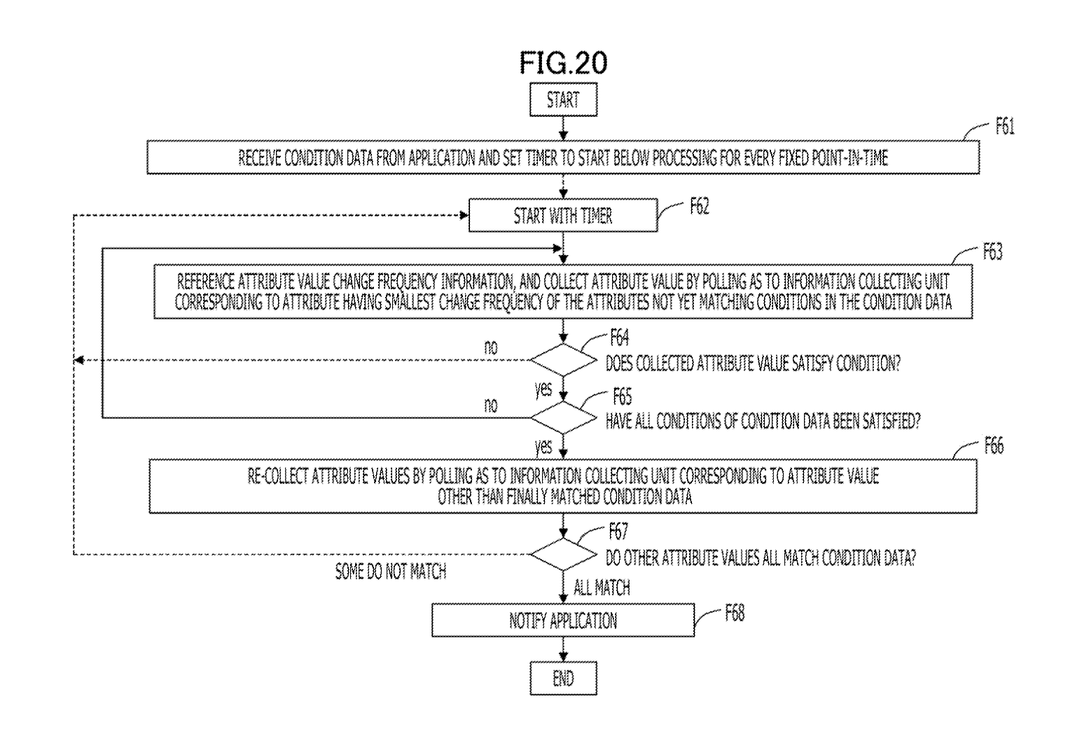

FIG. 20 exemplifies a processing flow of the verifying processing unit 14 in the case of using polling. Upon receiving the condition data from the application 61, the verifying processing unit 14 sets a timer to start the processing described below per fixed point-in-time (F61).

The verifying processing unit 14 is started by a timer with a fixed cycle (F62). Similar to the case in the second embodiment, the verifying processing unit 14 selects an attribute having the smallest change frequency of the attributes that have not yet matched the conditions in the condition data. The verifying processing unit 14 collects the attribute values by polling as to the information collecting unit 50A corresponding to the selected attribute values, until the selected attribute value satisfies the condition (F63, F64).

If the selected attribute value condition is satisfied (YES in F64), the verifying processing unit 14 similarly performs polling for the attribute having the next smallest change frequency of the attributes not yet matching the conditions (NO in F65). If all of the conditions in the condition data are satisfied by polling (YES in F65), the verifying processing unit 14 re-collects the attribute values by the polling from the information collecting unit 50A which corresponds to the attribute values other than the finally matched condition data (F66). The verifying processing unit 14 then confirms that all of the condition data has been satisfied (F67). Upon all of the conditions specified by the condition data being satisfied, the verifying processing unit 14 sends a notification to the application 61 (F68).

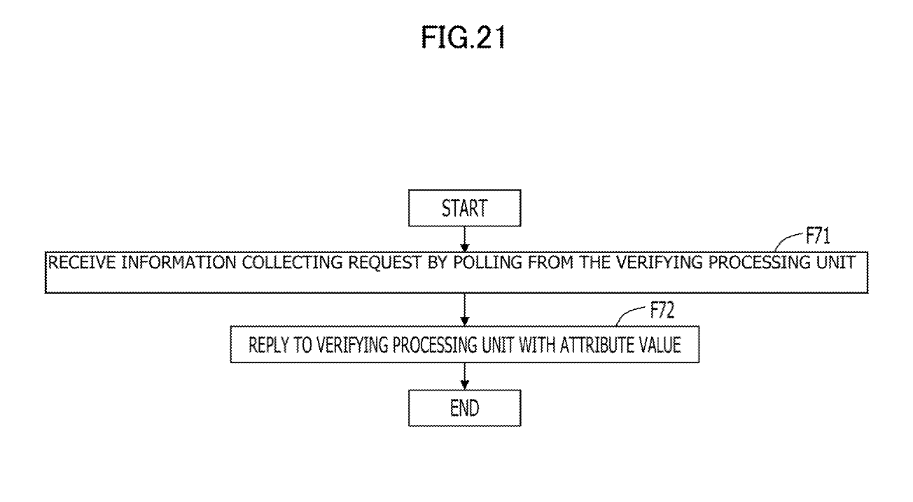

FIG. 21 exemplifies the processing flow of the information collecting unit 50A in the case of using polling. The processing herein only responds to an attribute value query from the verifying processing unit 14. That is to say, the information collecting unit 50A receives an information collecting request by polling from the verifying processing unit 14 (F71). The information collecting unit 50A responds to the verifying processing unit 14 with the collected attribute values (F72).

According to the processing of the third embodiment, by monitoring the attribute value having the smallest change frequency with polling, the number of time that other attribute values are monitored is decreased, and the sensors can be efficiently operated. Accordingly, for example, various types of detecting devices such as the information collecting unit 50A or the sensors can have reduced power consumption.

<<Computer-Readable Recording Medium>>

A program for a computer or other machine or device (hereafter, computer or the like) to realize one of the functions described above can be recorded in a recording medium that can be read by a computer or the like. By causing a computer or the like to read and execute the program of the recording medium, the function thereof can be provided.

Thus, a recording medium that can be read by a computer or the like refers to a recording medium which can accumulate information such as data or programs with electrical, magnetic, optical, mechanical, or chemical processes, and can read from the computer or the like. Examples of such recording media detachable from the computer or the like include flexible disks, magneto-optical discs, CD-ROM, CD-R/W, DVD, Blu-Ray disk, DAT, 8 mm tape, flash memory, and so forth. Also, examples of a recording medium fixed to the computer or the like include a hard disk, ROM (Read-Only Memory), and so forth.

According to the above-described embodiment, the efficiency of verifying processing between multiple attribute values and conditions can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions, and alterations could be made hereto without departing from the spirit and scope of the invention.

What is claimed is:

1. A non-transitory computer-readable recording medium to store a program that verifies condition data specifying conditions as to multiple attribute values of an object and the attribute values obtained from said object, said program causing a computer to execute a procedure comprising:
verifying processing to obtain a new attribute value after change for an attribute value having a smallest change frequency of attribute values not satisfying the conditions specified by said condition data, and to verify whether or not the new attribute value after said change satisfies the conditions of said condition data; and
processing to further execute said verifying processing as to other attribute values not satisfying the conditions specified by said condition data in the case that said new attribute value after change for the attribute value having the smallest change frequency satisfies said conditions.

2. The recording medium according to claim 1, said procedure further comprising:
storing change frequency information of attribute values relating to multiple objects sharing at least one attribute value in said computer, in a change frequency information storage unit that stores change frequency information for each attribute value of said objects.

3. The recording medium according to claim 1, said procedure further comprising processing of:
in the case of new attribute values after change being obtained in said verifying processing,
and in the case of a first attribute value changing between multiple attribute values, resulting in the other attribute values becoming value unknown due to being dependent on said obtained new attribute values;
rewriting the other attribute values specified in a dependency relation storage unit to unknown.

4. The recording medium according to claim 1, said procedure further comprising processing of:
calculating a change frequency per unit of time from an aggregate of past number of changes of the attribute values.

5. The recording medium according to claim 1, said procedure further comprising processing of:
calculating change frequency using different weighting as to change frequencies between a change history occurring in a first segment including a newest change history and a change history occurring before said one segment, of past change histories of the attribute values.

6. An information processing apparatus comprising:
a condition data storage unit to store condition data as to multiple attribute values of an object;
a change frequency information storage unit to store change frequency information of each attribute value of said object; and
a verifying processing unit to obtain a new attribute value after change for an attribute value having a smallest change frequency of attribute values not satisfying conditions specified by said condition data, execute verifying processing of whether or not the new attribute value after said change satisfies the conditions of said condition data, and execute said verifying processing as to other attribute values not satisfying the conditions specified by said condition data in the case that said new attribute value after change for the attribute value having the smallest change frequency satisfies said conditions.

7. An information processing method to verify condition data specifying conditions as to multiple attribute values of an object and attribute values obtained from said object, said information processing method comprising:
verifying processing, by a processor, to obtain a new attribute value after change for an attribute value having a smallest change frequency of attribute values not satisfying the conditions specified by said condition data, and to verify whether or not the new attribute value after said change satisfies the conditions of said condition data; and
further executing said verifying processing as to other attribute values not satisfying the conditions specified by said condition data in the case that said new attribute value after change for the attribute value having the smallest change frequency satisfies said conditions.
